(19) United States
(12) Patent Application Publication
(10) Pub. No.: US 2026/0279190 A1
(43) Pub. Date: Sep. 17, 2026

(54) SYSTEM AND METHOD RELATED TO ALERTS AND NOTIFICATIONS FOR A WORKSITE OR CONSTRCUTION SITE

(71) Applicant: EarthCam Inc., Upper Saddle River, NJ (US)

(72) Inventors: Brian Cury, Upper Saddle River, NJ (US); Juan Navas, Fair Lawn, NJ (US)

(21) Appl. No.: 19/565,001

(22) Filed: Mar. 12, 2026

Related U.S. Application Data
(60) Provisional application No. 63/770,398, filed on Mar. 12, 2025.

(51) Int. Cl. G08B 31/00; G06V 20/52; G08B 21/02

(52) U.S. Cl. CPC G08B 31/00; G06V 20/52; G08B 21/02

(57) ABSTRACT

A method for issuing a notification responsive to a worksite issue at a worksite or at a construction site. Alert triggers are identified as comprising a condition at the worksite or the construction site. Data is collected from multiple sensory devices disposed at multiple locations of the worksite or proximate thereto. The data relates to one or more alert triggers. Rubrics are created for determining whether an alert trigger state comprises a worksite issue and these rubrics are applied and analyzed using a current alert trigger state that is based on the data. A notification is issued if the current alert trigger state comprises a worksite issue.

### CROSS REFERENCE TO RELATED APPLICATION

The present application claims priority to the provisional patent application assigned application No. 63/770,398 filed on Mar. 12, 2025 (Attorney Docket Number 16569-014), which is incorporated herein in its entirety.

### BACKGROUND OF THE INVENTION

Worksite safety, asset protection, and regulatory compliance are vital to a worksite. The Occupational Safety and Health Administration, hereinafter referred to as ‘OSHA”, reports that one out of five workplace fatalities is a construction worker. OSHA also advises that falls from elevation account for one third of all deaths in construction. An average of 362 fatal falls occurred each year from 1995 to 1999, with the trend on the increase, according to OSHA. The following hazards, cited by OSHA, cause the most fall-related injuries: unprotected sides, wall openings, and floor holes; improper scaffold construction; unguarded protruding steel rebars; and misuse of portable ladders.

While falls are a significant cause of construction workplace fatalities, OSHA reports another leading cause of construction-related deaths is workers being struck by a heavy equipment vehicle. OSHA estimates approximately 75% of struck-by fatalities involve heavy equipment, such as a truck or crane.

According to OSHA, another significant cause of construction-related deaths is construction worker injury from cave-in of a trenching or excavation. Related to trenching and excavation is the potential struck-by hazards associated with heavy equipment, falling loads, and public vehicular traffic in close proximity to a trenching or excavation operation.

Worksite management struggles daily to mitigate worker injury and fatality. Reliance on safety spotters, safety training, and safety procedures have not been sufficient to eliminate worksite injuries and fatalities. In a large worksite, with many workers, it has not been possible to prevent worker injury and fatalities caused by falls from elevation, being struck by heavy equipment, trancing or excavation cave-ins.

### BRIEF DESCRIPTION OF THE DRAWINGS

The present invention can be more easily understood and the advantages and uses thereof more readily apparent when the detailed description of the present invention is read in conjunction with the figures wherein:

FIG. 1 illustrates method steps for a Client to request a comprehensive worksite Alert System.

FIG. 2 illustrates method steps to establish an Alert System for a Client Worksite with the worksite location information and user information.

FIG. 3 illustrates method steps that allow a Client to define the System Alerts needed, their frequency, recipients internal to the Client and external to the Client, and alert delivery methods.

FIG. 4 illustrates method steps to identify and determine the category and subcategory names of Objects to be detected and monitored on the Client worksite as an Alert subject.

FIG. 5 illustrates method steps to Select Standard Objects for a category of Objects and Objects to be detected for an Alert on the Client worksite.

FIG. 6 illustrates method steps to allow a Client to define the preferences for Alerts to be associated with the Client worksite.

FIG. 7 illustrates method steps to determine the equipment needed for an Alert.

FIG. 8 illustrates method steps to install equipment required to create, transmit and record an Alert.

FIG. 9 illustrates method steps to allow an operator to create an Alert Trigger, an Alert Trigger State, an Alert Trigger State Parameter, and Criteria for an Alert, and to allow a Client to edit, add or delete an Alert Trigger, an Alert Trigger State, and an Alert Trigger State Parameter and Criteria for an Alert.

FIG. 10 illustrates method steps to determine when an Alert Trigger State Parameter at a Client worksite has become adequate to create an Alert.

FIG. 11 illustrates method steps to transmit and deliver an Alert to a Client.

FIG. 12 illustrates method steps to create and maintain a digital regulatory compliant library docu-vault.

FIG. 13 illustrates a Client Project Folio.

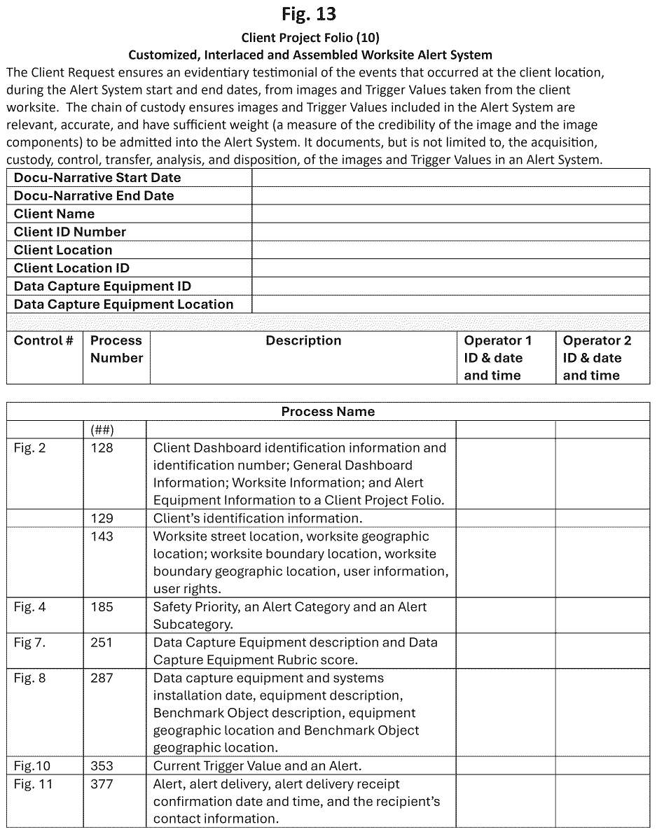

FIG. 14 is a list of the Docu-Vaults.

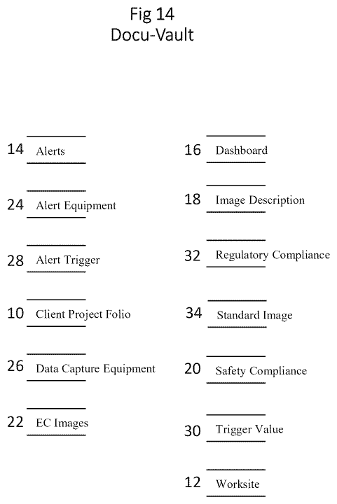

FIG. 15 is a list of Devices.

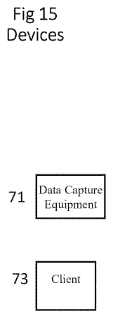

FIG. 16 is a list of the rubrics.

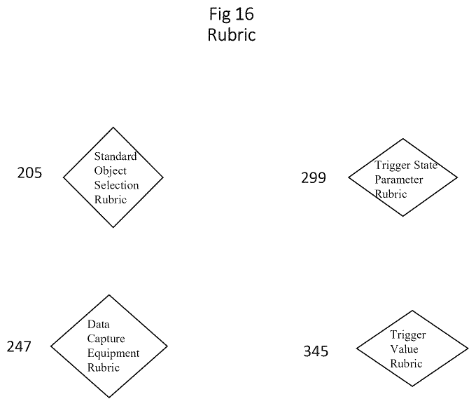

FIG. 17 illustrates drawing legends which defines a plurality of symbols, abbreviations, and line types used in the Alert System drawings.

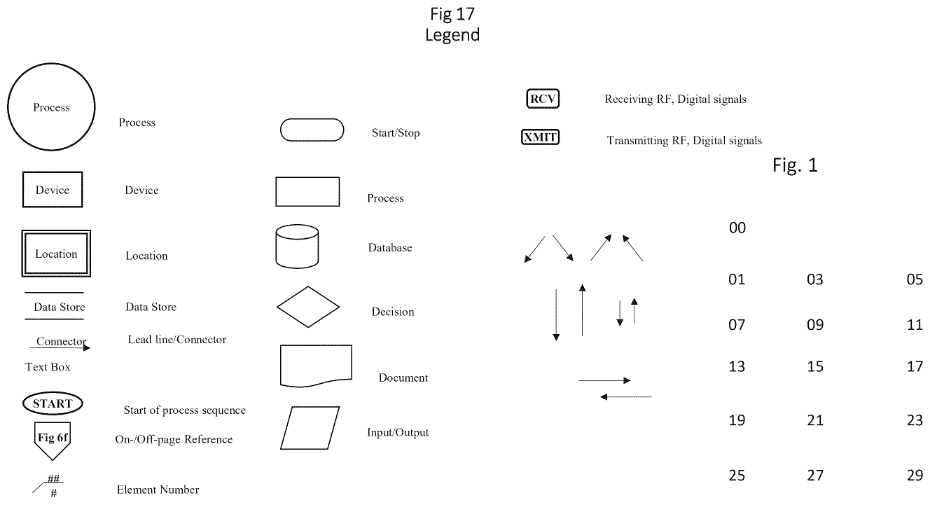

In accordance with common practice, the various described features are not drawn to scale but are drawn to emphasize specific features relevant to the invention. Like reference characters denote like elements throughout the figures and text.

### DETAILED DESCRIPTION OF THE INVENTION

### Overview of the Figures

Following is an overview of the major elements associated with each figure, method and process for Alerts including, but is not limited, the following alerts: Camera Online, Camera Tampering, Low Battery Charge, Insufficient Panel Voltage, Power Loss, Bandwidth, Weather Condition, NOOA METAR (Meteorological Aerodrome Report), Heat Warning, Cold Warning, Heat Index, Precipitation, Humidity, High Winds, Wind Gusts, Lightning, Lightening and People, High Winds and People, Concrete Truck, Compliance, Absence of PPE (personal protective equipment), Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.

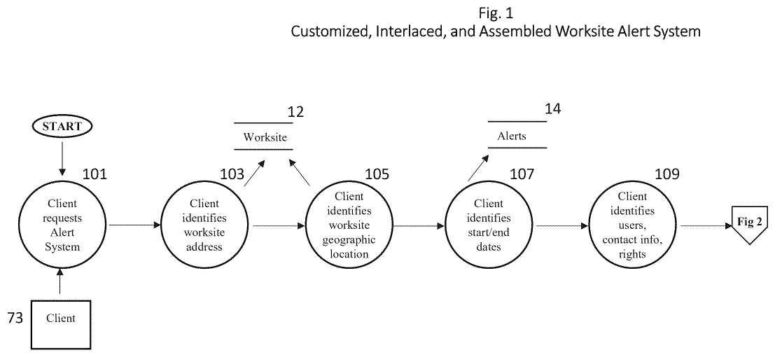

FIG. 1) Client requests an Alert System.
a) Client identifies the worksite location.
b) Client identifies the start date and approximate end date.
c) Client identifies contact information and user rights for each Alert recipient.

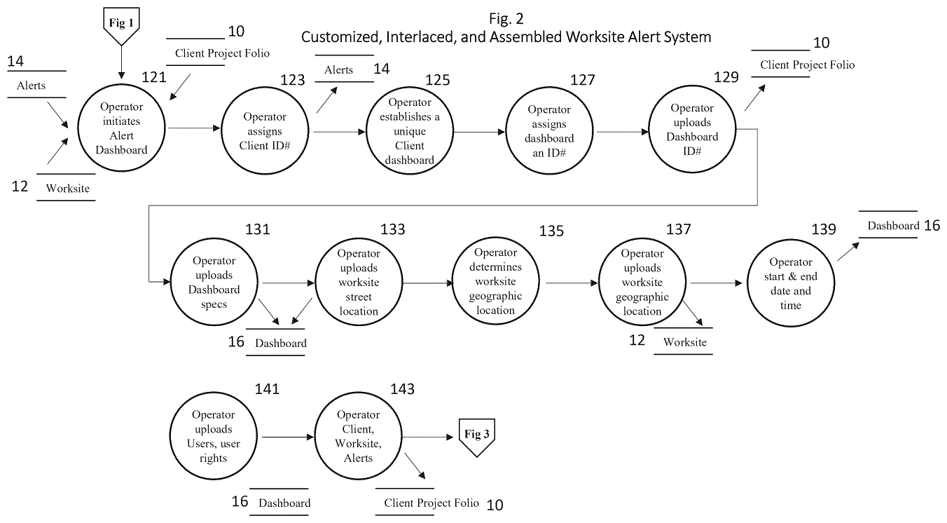

FIG. 2) An operator establishes an Alert System for a Client Worksite.
a) An operator creates a Client Project Folio, (10), Alerts Docu-Vault, and Worksite Docu-Vault, to initiate a worksite an Alert System Alert System Dashboard for a Client.
b) An operator determines the geographic coordinates for the worksite location boundary.
c) An operator uploads the geographic coordinates for the worksite location boundary to the Worksite Docu-Vault.
d) An operator uploads the following, but is not limited to the following, to a Client Project Folio: worksite street location, worksite geographic location; worksite boundary location, worksite boundary geographic location, user information, user rights.

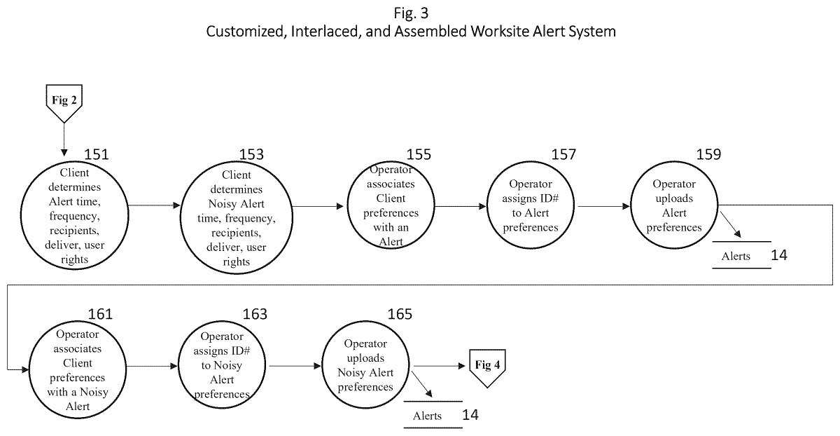

FIG. 3) Client defines, but is not limited to defining, the System Alerts needed, their frequency, recipients internal to the Client and external to the Client, and delivery method.
a) Client determines, but is not limited to determining, the preferences for Alerts including but is not limited to determining, the time, frequency, recipients, delivery method and user rights for an Alert and a Noisy Alert.
b) An operator uploads, but is not limited to uploading, the Client preferences for an Alert and a Noisy Alert.

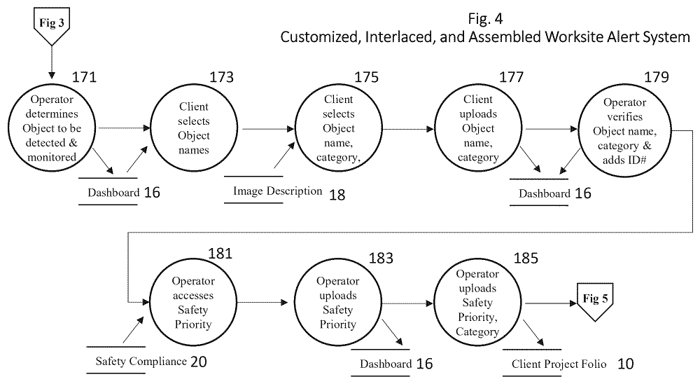

FIG. 4) Method to identify and determine the category and subcategory names of Objects to be detected and monitored on the Client worksite as a subject for an Alert.
a) A Client accesses selects the standard names for an Object category and sub-category but is not limited to a single category or sub-category, of Objects to recognize and detect as the subject of an Alert. An operator verifies a Client a category list, but is not limited to a category list, identifying, and describing Objects to be detected as a subject for an Alert and hereinafter called ‘Alert Category’ and ‘Alert Subcategory’.
b) An operator accesses the ‘Safety Priority’ and compliance information for an Alert Category and Alert Subcategory from a Safety Compliance Docu-Vault and provides a detailed description for a Safety Priority for an Alert Category and Alert Subcategory.

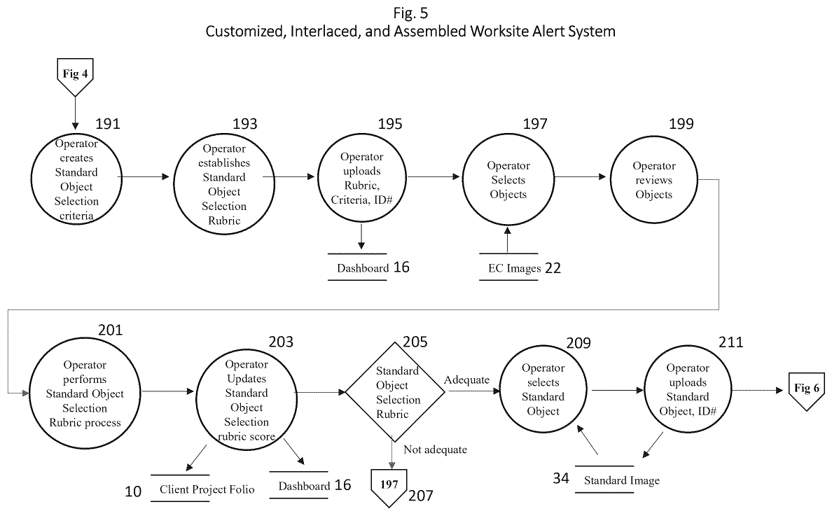

FIG. 5) Method to Select Standard Objects for a category of Objects and Objects to be detected for an Alert on the Client worksite
a) An operator establishes and uses a Standard Object Selection Criteria, Standard Object Selection Rubric, and rubric score for selecting Standard Objects which match Alert Category and Alert Subcategory descriptions from but is not limited to including Objects from, EarthCam proprietary EC Images Docu-Vaults and from third party augment Object data stores.
b) An operator selects Objects from an EC Images Docu-Vault and third-party data stores which match the descriptions of Objects associated with an Alert Category and Alert Sub-category.

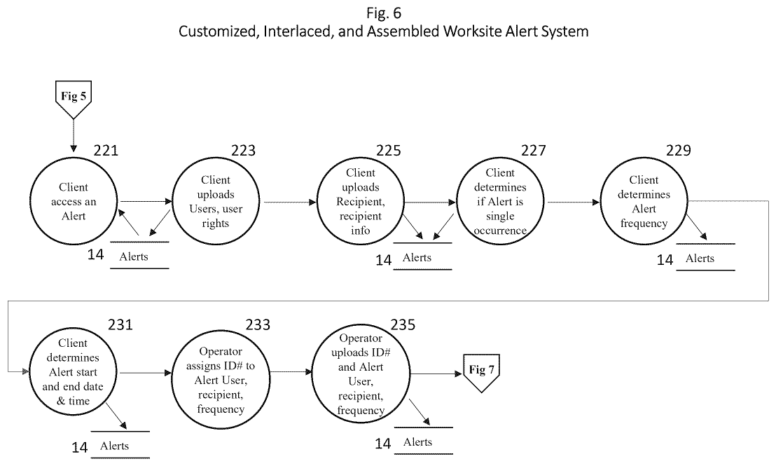

FIG. 6) Method to allow a Client to define the preferences an Alert.
a) A Client accesses an Alert Docu-Vault.
b) A Client accesses an Alert
   1) A Client identifies and uploads a user contact information, user rights, not limited to viewing, adding, deleting, modifying an Alert.
   2) A Client determines if the Alert is for a single or multiple occurrences.
   3) A Client determines, but is not limited to uploading, the frequency of occurrence, time of day, the day or days of the week for the Alert. A Client determines the start and end day and time for issuing the Alert.
c) An operator uploads the user, recipient, occurrences, frequency of occurrence, Alert start and end date and time to an Alert Docu-Vault.

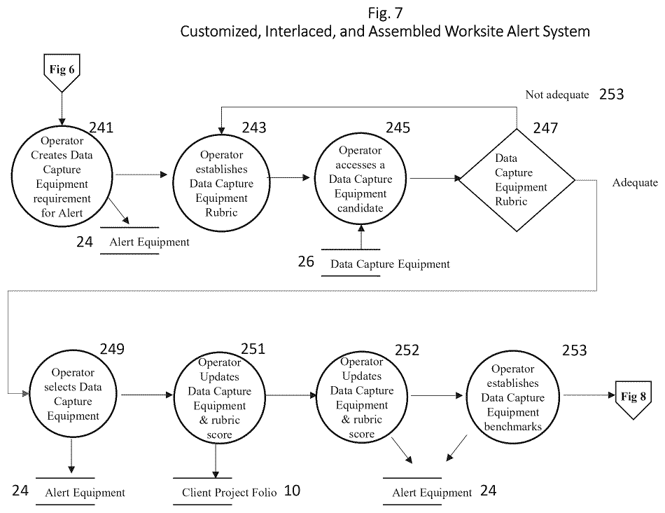

FIG. 7) Method to determine the equipment needed for an Alert.
a) Equipment for an Alert includes, but is not limited to including, cameras, sensors, internet of things devices, and other devices required for an Alert and are hereinafter called ‘Equipment’.
b) An operator establishes standard Equipment requirements, for an Alert.

1) An operator creates data capture requirements for Equipment required for an Alert.

2) An operator establishes and uses an Alert Equipment Criteria, an Alert Equipment Rubric, and a rubric score for determining if a piece of Equipment is adequate for the Alert.

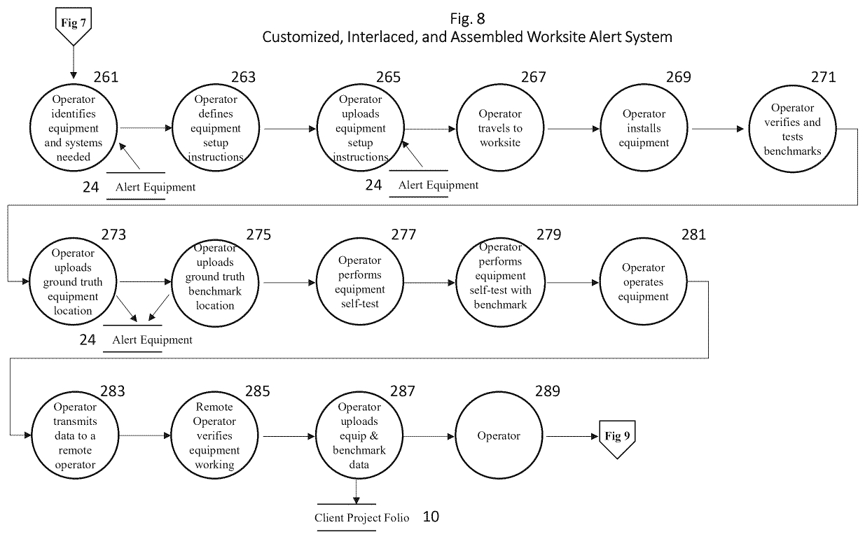

FIG. 8) Method to install equipment required to create, transmit and record an Alert.
a) An operator accesses an Alert Equipment Docu-Vault and identifies the equipment and systems needed for an Alert.
b) An operator installs the equipment and systems at the Client Worksite.

1) An operator gets ground truth geographic location for equipment Benchmark Objects for an Alert.

2) An operator performs a self-test for the Alert equipment and systems.

3) An operator verifies the equipment, and systems are working properly with the EarthCam Remote Control Center.

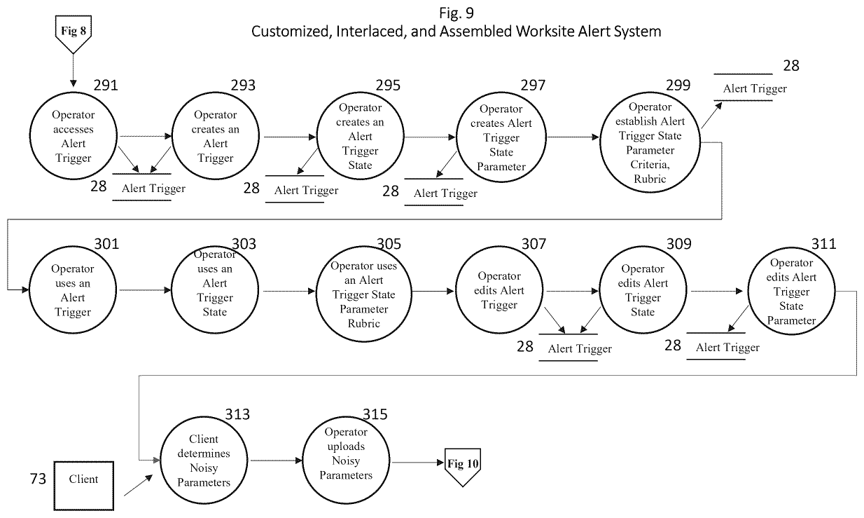

FIG. 9) Method to allow to allow an operator to create an Alert Trigger or Triggers, an Alert Trigger State, and an Alert Trigger State Parameter and Criteria for an Alert, and to allow a Client to edit, add or delete an Alert Trigger, an Alert Trigger State, and an Alert Trigger State Parameter and Criteria for an Alert.
a) An operator defines and creates an Alert Trigger, an Alert Trigger State, and an Alert Trigger State Parameter and Criteria for an Alert.
   1) An operator establishes an Alert Trigger for an Alert.
   2) An operator establishes an Alert Trigger State for an Alert.
   3) An operator establishes and uses an Alert Trigger State Parameter and Criteria for an Alert.
b) A Client edits, adds or deletes an Alert Trigger, an Alert Trigger State, and an Alert Trigger State Parameter and Criteria for an Alert.
c) A Client determines the Noisy Alert parameters for an Alert. A Noisy Alert parameter identifies when the alert may not be sent to a recipient.

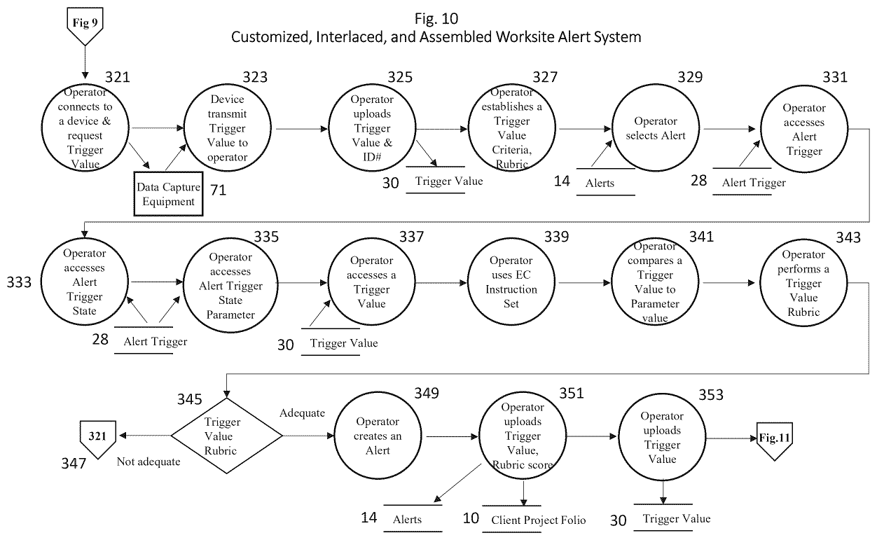

FIG. 10) Method to determine when an Alert Trigger State Parameter at a Client worksite has become adequate to create an Alert.
a) A process to determine the status of an Alert Trigger State Parameter for an Equipment device at a Client Worksite.
b) A process to determine if an Alert Trigger State Parameter is adequate for an Alert.
   1) An operator selects a Standard Object for an Alert Trigger associated with an Alert at a Client worksite.
   2) An operator accesses and selects a Field of View Object for the Client worksite, hereinafter called ‘Worksite Object’ from the Worksite Docu-Vault.
   3) An operator accesses a Standard Objects Docu-Vault and selects a Standard Object for an Alert Trigger associated with an Alert at a Client worksite.
   4) An operator uses an EarthCam Instruction Set, Algorithms, and Process for Object Detection and Recognition to identify an Alert Trigger in a Worksite Object.
   5) An operator uses a Standard Alert Trigger Criteria, a Standard Alert Trigger Rubric, and a rubric score for determining if an Object associated with an Alert Trigger from a Worksite Object matches a Standard Object for an Alert Trigger associated with an Alert at a Client worksite.
   6) An operator accesses the Alert Trigger State Parameter from an Alert Trigger Docu-Vault.
   7) An operator uses an Alert Trigger State Criteria and an Alert Trigger State Rubric to determine if the Alert Trigger State Rubric score is adequate to be the subject of an Alert.
   8) If the Alert Trigger State Rubric score is adequate, an operator creates an Alert.

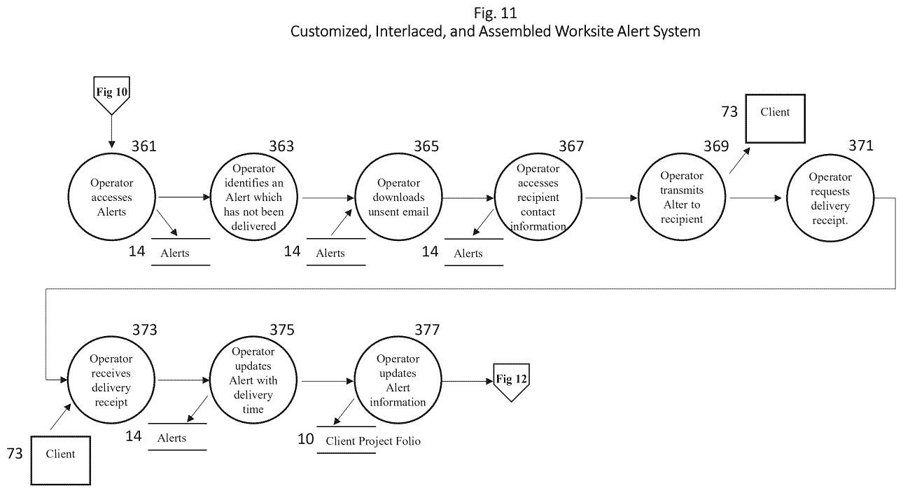

FIG. 11) Method to transmit and deliver an Alert to a Client.
a) An operator identifies an Alert which has not been transmitted to a recipient.
b) An operator downloads the untransmuted Alert.
c) An operator accesses, but is not limited to accessing, the recipient contact information, data transmission instructions, data transmission method, deliver address for the Alert from the Alert Docu-Vault.
d) An operator transmits the Alert to a Recipient.

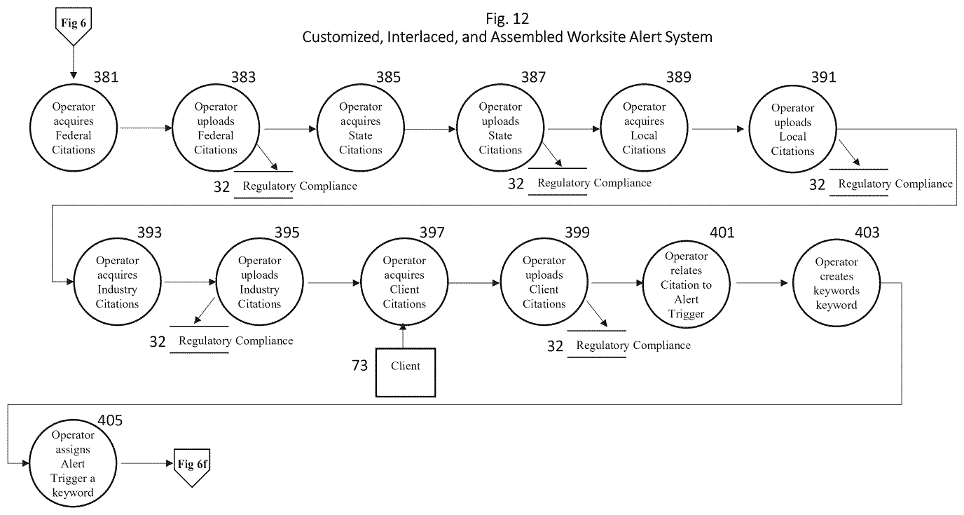

FIG. 12) Method to create and maintain a digital regulatory compliance library docu-vault.
a) Method to acquire, digitize, and maintain a library of, but is not limited to, federal, state, local government agency regulations, statutes, case law related to, but is not limited to, worksite activities.
b) Method to acquire, digitize, and maintain a library of, but is not limited to, industry regulations and best practices, related to, but is not limited to, worksite activities.
c) Method to acquire, digitize, and maintain a library of, but is not limited to, Client regulations, policies, procedures and practices, related to, but is not limited to, worksite activities.
d) Method to relate an Alert Trigger with, but is not limited to, a regulation, statute, case law, policy, procedure, or best practice.
e) Method to create, but is not limited to, keywords, relational indexes, normalized tables, concordance indexes, and optimized queries.

### Definitions

### Benchmark Object

As used herein, a Benchmark Object is used with, but not limited to being used with, sensors, equipment, images, or objects used with an Alert. A Benchmark Object may be, but is not limited to being, a physical object, a digital object, a marking on a physical object, a geographic location, a quantitative measurement, a qualitative measurement, a condition, a color, a distance, a radio frequency, a data set, a calculation, a standard marker, or a state of being and is hereinafter called “Benchmark Object”. A Benchmark Object may be used, but is not limited to being used, as a basis for the evaluation, comparison, description, reference of the performance or output of a sensor or equipment, or direction and speed of an object used herein. An operator may establish how a Benchmark Object is used. An operator may establish the measurement, value and deviation of Benchmark Object. A benchmark may be located but not limited to being located on a Client worksite.

### Boundary

The edge of a property, as used in an Alert System, is herein called a boundary. A worksite boundary may be determined by using a boundary method including but not limited to including public records describing the demarcation of the property; online mapping applications; metes and bounds survey using natural landmarks; a plat map or parcel map; Client provided description; plat map or parcel map; survey markers or monuments that define the property line; survey pins or property markers; or geographic coordinates; or GPS coordinates, or an EarthCam Algorithms and Instruction Set (73) and process which converts ground truth distance from a camera to a boundary point into pixels. A boundary is used to define the edge of a worksite, Field of View, or other physical or digital dimension.

### Client

A Client is, but not limited to being, a customer, subscriber, an individual, group of individuals, business, enterprise, organization, government agency, or other entity or an Operator.

### Client Project Folio

A Client Project Folio is an archival and current curated record and log of material information about a Worksite Alert System including, but is not limited to including, order entry system information, sales order information, work order information, or information and processes required to produce a Worksite Alert System. A Client Project Folio includes a method of logging and storing material information for and about the above in a Docu-Vault.

### Dashboard

A worksite Alert System dashboard is a unique visual display for a Client worksite Alert System. It is a graphical user interface that provides a worksite Alert System Client with a centralized, at-a-glance view of key worksite information including but not limited to worksite key performance indicators, and data trends through charts, graphs, and tables. It displays information about, but not limited to, users and user rights, target objects, target object and waif target object genres and categories, Alert System grid structure, vital objects, vital object alerts, and plenary images. It also includes bunt limited to including information about Alert Categories, Alert Triggers, Alert Trigger Status, Alert Trigger Status Parameters. It also includes, but not limited to including information about reports, worksite Alert System start and end date, number of images, camera scans and tilts. Information contained in a worksite Alert System dashboard is stored and maintained in an Alert System Dashboard Docu-Vault (26) and in other Docu-Vaults.

### Data Capture Equipment

Data Capture Equipment for an Alert System includes, but is not limited to including, cameras, sensors, alarms, lights, locks, motion sensors, measuring instruments, radiation sensors, weather equipment, air particle sensors, windspeed sensors, internet of things devices, remote devices, and other devices required to capture but not limited to information, data and images for at least one Alert. Data Capture Equipment for an Alert System may be but not limited to stationary, mobile, aerial, marine or submarine devices. Data Capture Equipment for an Alert System are hereinafter called ‘Equipment’ or ‘Camera’.

### Digital Object Bounding Box

A bounding box, volume or region, is a defining geometric shape, surrounding or enclosing a digital object, a group of objects or an image in a digital image hereinafter called object. The bounding box defines the location and size of a digital object in a two-dimensional, three-dimensional, or four-dimensional image space.

A bounding box in a two-dimension image may be represented by rectangles but not limited to rectangles. The sides of the rectangle run parallel to the x-axis and γ-axis of a digital object. The minimum and maximum values of the x-axis and γ-axis are specified by the pixel coordinates of the rectangle corners and determine the pixel size of the rectangle. The size and center point of the rectangle may be used to create an enclosing box about a digital object. A bounding box may also be represented by circle, cylinder, or sphere with a defined axis, radius and vector. The axis, radius, and vector of the circle, cylinder or sphere may be used to create an enclosing circle, cylinder, or sphere about a digital object.

Three dimensional rectangular bounding boxes may be, but are not limited to being, represented by a parallelepiped, whose sides are parallel to the x-axis, y-axis, and z-axis of a digital object. The minimum and maximum values of the x-axis, y-axis and z-axis are specified by the pixel coordinates of the parallelepiped corners and determine the pixel size of the parallelepiped. The size and center point of the parallelepiped can be used to create an enclosing bonding box about a digital object.

A rectangular, circular, cylindrical, spherical, or parallelepiped bounding box are hereinafter called bounding box.

A bounding box may be used to identify and categorize objects. For example, a bounding box may be used to identify a digital object such as a person, car, wheelbarrow, dumpster, crane, frontend loader, or lightning from a larger image which would include other digital objects. A bounding box may be used to help crop, resize, rotate or accrete a digital object.

### Data Transmission

Data transmission includes digital and analog data over a communication medium and not limited to communication between at least one data capture device to another data capture device; between a data capture device and an EarthCam Control Center; between a data capture device and a Client; between a Client and an EarthCam Control Center. A data transmission may occur through but not limited to wired not limited to fiber cables, fiber optics or wireless not limited to Wi-F, RF, infrared, satellite channels and enables the movement of data between but not limited to between data capture devices; and between data capture devices and an EarthCam Control Center; and between data capture devices and a Client; and between an EarthCam Control Center and a Client. Data transmission may be synchronous or asynchronous; it may include but not limited to sending data as continuous streams or in packets. Data transmission includes but not limited to a network infrastructure including but not limited to hardware, software, an EarthCam Algorithms and Instruction Set, and communication protocols necessary to transmit data. A network infrastructure includes but not limited to including data capture devices, routers, switches, hubs, modems, access points, and network cables, and protocols and standards not limited to Ethernet, TCP/IP, and Wi-F.

### Digital Object Image Flag

A digital object image flag, hereinafter called ‘flag’ may be used to identify a target object image within, but not limited to, another image, an image in its entirety or larger image. An image other than a target image, an image in its entirety or image larger than a target image is hereinafter called a ‘Plenary Image’ but not limited to being called ‘image’ or ‘Plenary Image’.

A plenary image may contain many digital objects such as people, cars, wheelbarrows, dumpsters, cranes, frontend loaders, snow, or lightning. A flag may be used but not limited to being used for digital objects which may appear in an external or internal plenary image of a worksite but not limited to a worksite.

A flag is used to quickly and accurately identify one digital object among many digital objects. A flag may have two parts, an alphanumeric identifier and a border. The alphanumeric identifier describes and identifies the digital object. It may appear at the top, but not limited to the top, of the flag. The border may be, but not limited to being, rectangular or circular and encloses the digital object. The alphanumeric identifier and the border may be the same color but not limited to the same color.

### Digital Object Veil

A digital object veil is used to identify a target object image within, but not limited to, a ‘Plenary Image’. For example, a plenary image may contain many objects including, but not limited to, construction materials, glass, carpet, bricks, drywall, plywood, studs, and doors. A veil may be used, but not limited to being used for digital objects which may appear in an internal or external plenary image of a worksite but not limited to a worksite.

A veil has a color and is used to quickly and accurately identify one object among many objects by a specific color code. A unique color code may be used to identify a specific type, or class of construction material, but not limited to, a construction material. A colored veil covers the target object within the target object bounding box. A veil cover may have, but not limited in having, a 20 percent opacity. A veil may cover the target object with a unique color without obscuring the identity, shape, outline or form of the target object.

### Docu-Narrative

A target object image and an image are used, but is not limited to being used, in a Docu-Narrative and an Alert. A Docu-Narrative is a plurality of images associated with a Client Location but is not limited to a Client Location within a specific time range. A Client Location is outdoor, but is not limited to being an outdoor place, area, acreage, park, bridge, tunnel, or worksite, and not limited to a worksite, hereinafter called ‘worksite’. Images from the worksite are created and maintained with a multiple step operator certification and authentication process. The images are not used for facial recognition, gathering of personally identifiable information or enforcement against individuals. The certification and authentication process includes, but is not limited to including, an image chain of custody. The image chain of custody uses, but is not limited to using, an evidentiary quality image creation, image maintenance, image recording and image logging process. Images in a Docu-Narrative are not altered, concealed, falsified, or destroyed.

### Docu-Vault

A Docu-Vault is a secure data store for images used in a Docu-Narrative and worksite Alert System. A Docu-Vault uses advanced data and physical security. The data security for the Docu-Vault includes, but is not limited to, data encryption, secured socket certificates, digital authentication, access rights management with multiple authentication layers and backup systems. The security for the physical server site includes, but is not limited to, alarmed access points, climate control, fire extinguisher and suppression, moisture detection, limited secure personnel access, no external windows, and a vault-like environment.

### EarthCam Control Center

An EarthCam Control Center is a physical facility remote from a Client worksite location. Access to the secure and requires prior authorization. Access within the facility is secure, electronically controlled, and restricted requiring prior authorization to move from one part of the facility to another. The facility includes but is not limited to, a plurality of Docu-Vaults, camera laboratories, redundant automatic standby power generators, administrative personal, technicians, and Operators. The facility includes but not limited to including redundant communication systems including but not limited to dial up telephone, RF communications, internet access, voice over IP, satellite, and private wire.

### Evidentiary Trigger Value Chain of Custody

An operator time stamps and updates the Client Project Folio with a two-level certification and authentication for a Trigger Value chain of custody including, but is not limited to including, a current Trigger Value identification number, docu-vault storage identification, and a date and time for an evidentiary quality current Trigger Value creation, current Trigger Value augmentation, current Trigger Value maintenance, current Trigger Value recording and current Trigger Value logging process in a Client Project Folio and updating a docu-vault.

### Images

A plenary image is an image other than a target image, an image in its entirety or image larger than a target image is hereinafter called a ‘Plenary Image’ but not limited to being called ‘image’ or ‘Plenary Image’. A plenary image may contain, but not limited to containing, many digital objects such as people, cars, wheelbarrows, dumpsters, cranes, frontend loaders, snow, or lightning.

A ‘Target Object Image’ is a photographic image of a target object within a larger plenary. An image, an object of interest within the plenary image. A target object image is a complete image, in its entirety, of an object.

A ‘Target Object Waif Artifact image’ is a photographic image of a part or component of a target object image.

A ‘Ground Truth Image’ is a high-quality photograph (i.e., with sufficient detail and without obstructions) of a Target Object or a Target Object Waif Artifact. Such “Ground Truth Images” may be taken at a Client's worksite. A ‘Curated Image’ is an EarthCam proprietary known good image (e.g., high quality with no obstructions) of a target object or a target object waif artifact. These images are stored in a Curated Images Docu-Vault.

### Image Evidentiary Chain of Custody

An operator uses an EarthCam Algorithms and Instruction Set time stamps and updates the Client Project Folio with a two-level certification and authentication for an image chain of custody including, but is not limited to including, an image identification number, docu-vault storage identification, and a date and time, when an image or data is captured, for an evidentiary recording and logging process in an Alert System. All images and data, captured from a Client worksite location, are retained and preserved unchanged in an Alert System. As included herein, the term Image, Parent Image, Child Image or Plenary Image also means the term Data, Parent Data, Child Data or Plenary Data.

To maintain a reliable an Evidentiary Image Chain Of Custody, all images from a Client worksite location are always retained unchanged. Original images are also referred to as parent images in an Alert System. A Child Image record is a duplicate of a Parent Image record and is always associated with the Parent Image record. A Child Image record may be created to resolve image defects in the parent while the Parent Image record is preserved unchanged. An entire Child Image record or an image region may be accreted, modified, or hidden from the view or Alert which a Client may see. An accreted Child Image record is used to improve the clarity of an Alert in an Alert System and thereby promote worksite safety and regulatory compliance.

An operator uses an EarthCam Algorithms and Instruction Set to perform processes to support artificial intelligence regulatory and industry best practice compliance. An operator uses EarthCam Algorithms and Instruction Set to maintain safe, transparent, traceable, non-discriminatory and environmentally friendly Alert System. An Image Evidentiary Chain Of Custody does not use cognitive behavioral manipulation of people or specific vulnerable groups; classifying people based on behavior, socio-economic status or personal characteristics; and biometric identification and categorization of people. An operator uses an EarthCam Algorithms and Instruction Set to disclose content created in Child Plenary Images; and to prevent Child Plenary Images from including illegal content.

An operator uses an EarthCam Algorithms and Instruction Set to continually certify an Evidentiary Image Chain Of Custody and authenticates all Parent and Child Image records exist, and no Parent Image record has been destroyed, changed, augmented or missing.

To maintain a reliable an Evidentiary Image Chain Of Custody, all data from a Client worksite location are always retained unchanged. Original data are also referred to as parent data in an Alert System. A Child Data record is a duplicate of a Parent Data record and is always associated with the Parent Data record. A Child Data record may be created to resolve data defects in the parent data while the Parent Data record is preserved unchanged. An entire Child Data record or a portion of data element may be accreted, modified, or hidden from an Alert or report which a Client may see. An accreted Child record is used to improve the clarity of an Alert report in an Alert System and thereby promote worksite safety and regulatory compliance.

An operator uses an EarthCam Algorithms and Instruction Set to perform processes to support artificial intelligence regulatory and industry best practice compliance. An operator uses EarthCam Algorithms and Instruction Set to maintain safe, transparent, traceable, non-discriminatory and environmentally friendly Alert System. Data in an Image Evidentiary Chain Of Custody does not use cognitive behavioral manipulation of people or specific vulnerable groups; classifying people based on behavior, socio-economic status or personal characteristics; and biometric identification and categorization of people. An operator uses an EarthCam Algorithms and Instruction Set to disclose content created in Child Data or Child Plenary Data and to prevent Child Plenary Data from including illegal content.

An operator uses an EarthCam Algorithms and Instruction Set to continually certify an Evidentiary Image Chain Of Custody and authenticates all Parent and Child Data records exist and no Parent Data record has been destroyed, changed, augmented or missing.

### Image Category

An image category is an image classification description based on broad characteristics of an object which is the subject of an image. An image classification relating to, but not limited to, the role, category, and significance of an image to a worksite Alert System. An image category includes, but are not limited to including, target objects, target object waifs, non-target objects. A category description of an object image may include, but not limited to including, an Alert System importance rank.

### Location

A location is an identifiable place within, but not limited to being in, a worksite property boundary. The location may be defined by the distance from a camera or equipment, and the height above or below the average mean sea level of the location, and the height of the location relative to the height of the camera or equipment, and the compass position, in degrees, of the location relative to the compass heading for a camera lens and equipment. A location may be determined by using a location method including but not limited to public records describing the demarcation of the property; online mapping applications; metes and bounds survey using natural landmarks; a plat map or parcel map; plat map or parcel map; survey markers or monuments that define the property line; survey pins or property markers; or geographic coordinates or GPS coordinates.

### Operator

As used in an Alert System herein, an ‘operator’ can be, but not limited to being, any of the following or combination of any of the following: a person at a worksite, or a person remote from a worksite, or an EarthCam employee, or an EarthCam contractor, or an equipment resident computer or chipset, or a local computer, or a remote or distributed computer or chipset, or data capture equipment, or a digital instruction set, or an EarthCam Algorithms and Instruction Set criteria, rubrics and rubric scores (73).

### Plenary Data Element

A Plenary Data Element is a data element captured by data capture equipment of a worksite Alert System. A Plenary Data Element may include data from, but not limited to sensors, alarms, lights, locks, motion sensors, measuring instruments, radiation sensors, weather equipment, air particle sensors, windspeed sensors, internet of things devices, remote devices, and data capture devices. The last Plenary Data Element, of a worksite Alert System, captured by data capture equipment and transmitted to an operator is hereinafter called a ‘Current Plenary Data’.

### Plenary Image

A Plenary Image is an image captured by data capture equipment of a worksite Alert System. It is an image other than a target object image, or an Unabridged Image. A Plenary Image may contain, but not limited to containing, many images of objects such as people, cars, wheelbarrows, dumpsters, cranes, frontend loaders, snow, or lightning. The last Plenary Image, of a worksite Alert System, captured by data capture equipment and transmitted to an operator is hereinafter called a ‘Current Plenary Image’.

### Remote Operator

As used in an Alert System herein, a ‘remote operator’ can be, but not limited to being, any of the following or combination of any of the following at a worksite or not at an EarthCam control center: a person or an EarthCam employee, or an EarthCam contractor, or Surveyor, or an equipment resident computer or chipset, or a local computer, or a remote or distributed computer or chipset, or a digital instruction set, or a sensor, or data collection device, or an EarthCam Algorithms and Instruction Set (73) in an Alert System.

### Standard Object

As used in an Alert System herein, a Standard Object is a general representation of an object category located on a Client worksite. A standard object is recognized by but not limited to a Client, industry practice, or government regulation to describe an object to be detected associated with an Alert Category. A standard object is recognized by but not limited to a Client, industry practice or government regulation to describe a representative sample of an Alert Trigger. A standard object may include, but is not limited to including, a physical object, an image of a physical object, a person, vehicle, equipment, materials, Client defined Objects, sensor measurement, environment condition, weather condition, event, regulatory compliance condition, Client defined conditions, a data element, or an information item, word or phrases and is hereinafter called ‘Standard Object’.

### Worksite

A worksite or Client worksite may be a Client Location. It can be outdoors, but is not limited to an outdoor place, area, acreage, park, bridge, tunnel, or worksite, and not limited to a construction worksite, hereinafter called ‘worksite’ in an Alert System. A worksite may be above or below the ground and includes, but is not limited to including, structures, people, equipment, vehicles, materials, air space, and ground below the surface. A worksite may be indoors. A worksite may include an area or property not part of a Client worksite yet adjacent but not limited to adjacent to a Client worksite.

### Alert Components

### Alert Category

An Alert may be assigned an Alert Category but not limited to a single category. Alert Categories include, but are not limited to including System, Electric Power, Weather, Severe Weather, Weather Safety, People Safety, Vehicle and Object Safety, and Safety and Regulatory.

The System Category includes, but not limited to including, alerts for Camera Online & Offline Monitor (hereinafter called ‘Camera Online’), Camera Tampering and Noisy’ Alerts.

The Electric Power Category includes, but not limited to including, alerts for Low Battery Charge, Insufficient Panel Voltage, Power Loss for Camera and other Devices hereinafter called ‘Power Loss’ and Bandwidth.

The Weather Category includes, but not limited to including, alerts for Weather Conditions, NOOA METAR Condition Alerts hereinafter called ‘NOOA METAR’, Heat Warning-Over 90 F, Cold Warning-Under 32 F, and Heat Index-Over 91 F.

The Severe Weather Category includes, but not limited to including, alerts for High Winds-Over 25 MPH Wind Gusts over 35 MPH, Lightning, Precipitation rain or snow over 0.75 inches, and Humidity over 90%.

The Weather Safety Category includes, but not limited to including, alerts for Lightning and a Person at Height hereinafter called ‘Lightening and People’, High Winds and Person at Height hereinafter called ‘High Winds and People’, Precipitation, Freeze and Concrete Truck hereinafter called ‘Concrete Truck’, and Safety, Security, Regulatory Compliance hereinafter called ‘Compliance’.

The People Safety Category includes, but not limited to including, alerts for Absence of Personal Protective Equipment (PPE), Person at Height, Person to Person proximity hereinafter called ‘People-to-People’, Person to Vehicle proximity hereinafter called ‘People-to-Vehicle’, and Loitering.

The Vehicle and Object Safety Category includes, but not limited to including, alerts for Vehicle-to-Vehicle Proximity hereinafter call ‘Vehicle-to-Vehicle’,

Selected equipment is detected hereinafter called ‘Equipment’, Any Object Detection hereinafter called ‘Objects’, and Dumpster empty, full, removal hereinafter called ‘Dumpster’. The Safety and Regulatory Category includes, but not limited to including, alerts for Fence Guard, Airborne Substances, and Regulatory Alerts. The Client Custom Alert Category includes, but not limited to including, alerts for custom alerts defined by a Client.

An Alert Category may include a ‘Safety Priority’ and compliance information for an Alert Category. An operator provides a detailed description for a Safety Priority for an Alert Category and Alert Subcategory. A Safety Priority indicates, but is not limited to indicating, the regulatory, industry and Client safety concern associated with the Object. Safety Priority may include an alphanumeric value.

Alert Categories and Sub-Categories, names, descriptions, and information are stored in the Safety Compliance Docu-Vault. Alert Categories and Alert Subcategories are maintained by an operator.

### Alert Triggers

An Alert Trigger may include, but is not limited to including, a physical object, an image of a physical object, a person, vehicle, equipment, materials, Client defined Objects, sensor measurement, environment condition, weather condition, event, regulatory compliance condition, Client defined conditions, a data element, or an information item, word or phrases and is hereinafter called ‘Object’. An Alert Trigger may include a plurality of Objects. An Alert Trigger is also a digital representation of a physical object, an image of a physical object, a person, vehicle, equipment, materials, Client defined Objects, sensor measurement, environment condition, weather condition, event, regulatory compliance condition, Client defined conditions, a data element, or an information item, word or phrases The presence, absence or state of being of an Alert Trigger may determine if an Alert starts, stops, is active or is inactive or is dormant or is dismissed.

### Alert Trigger State

An Alert Trigger State is a current, but is not limited to current, condition of being for an Alert Trigger including but is not limited to, structure, form, digital representation, constitution, phase, activity, presence or absence of an Alert Trigger at a Client worksite. An Alert Trigger State may include a plurality of Alert Trigger States.

### Alert Trigger State Parameter and Criteria

A trigger parameter provides a measurable quantitative reference for an Alert Trigger State. It also provides a criteria, rubric and rubric score to evaluate if the current Trigger State warrants creating and transmitting an Alert. Alert Trigger State Paraments are described in the Alert Trigger Docu-Vault (FIG. 125) and the table below. The Client collaborates with an operator to establish the Alert Trigger State Parameters, which is determined for each worksite. The measurable references for an Alert Trigger State Parameter might differ, but is not limited to differing, because of the worksite geographic location, or the type of activity at a worksite, the Client's worksite rules, or the geology of a worksite or regulations applicable to a worksite. For example, a 30° F. cold weather alert for Bangor Maine might not be low enough, but it would be frightful for Miami, Florida. Loitering at a Government worksite in the White Sand Desert area would have different parameters for loitering at Florida Disney worksite. The parameters for the degree and type of airborne substances in a lower Manhattan worksite would be markedly different from the parameters of a worksite in southeast Montana.

### Noisy Alert

Alerts which include, but are not limited to including too much, too little, not actionable, insignificant, not relevant data or information about an Alert Trigger are called ‘Noisy Alerts”.

### Regulation Alert Trigger State Parameter and Criteria

A worksite is one of the most dangerous environments for someone to work. The activities, actions, interactions and location of people, vehicles, equipment, and materials, hereinafter called ‘occupants’, are governed by a myriad of regulations to protect the occupants of a worksite. Regulations also govern the activities, actions, interactions, and location of occupants relative to systems and structures external and unconnected to a worksite including, but is not limited to including, weather, environment, subsurface and atmospheric.

A Regulation Alert Trigger State Parameter and Criteria includes a regulation, case law, rule, instruction, best practice, or requirement and not limited to the foregoing, belonging to, but is not limited to, a federal, national, state, province, county, city, local, or international government, but is not limited to, government, agency, trade association, business entity, trade union or Client as described in the compliance parameter being broken, lapsed, transgressed or another action and hereinafter called ‘regulation parameter.’

### Trigger Value

The output of Data Capture Equipment is hereinafter called a ‘Trigger Value’. Data Capture Equipment output includes, but are not limited to including, images from a camera, data from a sensor, on/off data indicator from an alarm, locked/unlocked data indicator from a lock, open/closed data indicator from a lock, an image which present or absent, an object which is present or absent, the geographic location of an object, the geographic location of an image, temperature, humidity, windspeed, wind direction, and precipitation rate from weather equipment, a Meteorological Terminal Air Report from a near airport for NOOA METAR.

### Purpose of the Invention

The invention solves the above-mentioned problems.

A worksite may experience events and issues including production, performance, scheduling, safety, health, environment, catastrophic, and disastrous issues and events, and also regulatory, industry standards and Client regulations hereinafter called ‘worksite issue’.

A purpose of the invention may be to use one or more types of data capture equipment or devices that together or independently identify a worksite issue or a combination of worksite issues.

Another purpose of the invention is to notify the Client of a worksite issue or combination of worksite issues or a pending worksite issue.

It is noted that in the technical description of the invention, references are frequently made to a target object image, which is a complete image, in its entirety, of an object. Target object waif artifact images are also referred to herein and defined as a part or a component of a target object image.

So that alert conditions can be accurately determined by the present invention, it is typically necessary to augment a target object waif artifact image to generate a complete target object image, after which an accurate assessment can be made as to whether to issue a notification based on application of relevant rubrics.

The methods and systems for generating such a target object (complete) from incomplete (waif) images is described in co-owned and pending application entitled: A Method to Identify and Augment an Incomplete Target Object Image to Form a Complete Composite Image of The Target Object at a Worksite and an Apparatus for Executing Said Method, filed on Jun. 5, 2025 and assigned application Ser. No. 19/229,392. (Attorney Docket Number 16569-007US1)

As described herein, data collected as related to an alert trigger state may, in certain situations, not indicate (according to the application of applicable rubrics) a current worksite issue. But application of other rubrics may indicate or suggest that such a worksite issue may, however, occur in the near term. Generally, occurrence of a near term worksite issue (and issuance of a notification responsive thereto) suggests that present conditions, if not abated, may result in a worksite issue within the next few minutes. Such near-term worksite issues should therefore generate a immediate notification. Waiting until the worksite issue actually occurs may cause unnecessary damage and/or injury. But to predict that a worksite issue may occur within a couple hours based on current data, is generally considered too speculative and issuance of a notification not warranted.

A ‘Ground Truth Image’ is a high-quality photograph (i.e., with sufficient detail and without obstructions) of a Target Object or a Target Object Waif Artifact. Such “Ground Truth Images” may be taken at a Client's worksite.

A ‘Curated Image’ is an EarthCam proprietary known good image (e.g., high quality with no obstructions) of a target object or a target object waif artifact. These images are stored in a Curated Images Docu-Vault.

FIG. 1: Client Requests an Alert System

As illustrated in FIG. 1 this method comprises a plurality of sub-methods or sub-processes, as set forth below, for a Client to request a comprehensive worksite Alert System.

FIG. 1) Method for a Client to request a worksite comprehensive Alert System
a) Client requests an Alert System for a Client worksite location. (101)
b) Client identifies the worksite address and street location, and uploads address to Worksite Douc-Vault (12). (103)
c) Client identifies the worksite geographic location and uploads the geographic location to the Worksite Docu-Vault (12). (105)
d) Client identifies the start date and approximate end date for the Alert System and uploads start date and time, and the approximate end date and time to the Alerts Docu-Vault (14). (107)
e) Client identifies the name, title, contact information and user rights for each recipient and uploads the information to the Alert Docu-Vault 14). (109

FIG. 2: Operator Establishes an Alert Dashboard

As illustrated in FIG. 2 this method comprises a plurality of sub-methods or sub-processes, as set forth below, to establish an Alert System Dashboard for a Client worksite with worksite location information and user information.

FIG. 2) Method to establish an Alert System for a Client Worksite with the worksite location information and user information.
a) An operator creates and accesses, but is not limited to accessing, a Client Project Folio, (10), Alerts Docu-Vault (14), and Worksite Docu-Vault (1), to initiate an Alert System Dashboard for a Client worksite. (121)
b) An operator identifies a Client for an Alert System process and assigns Client a unique ID number. The unique Identification Number incorporates a numeric chronological feature, and a multi-level and hierarchical sequence numbering feature. An operator uploads a Client's identification information to a Client Project Folio (10) and the Alert Docu-Vault (14). (123)
c) An operator establishes a unique dashboard for a Client and a Client worksite to recognize and detect Objects on the worksite and to identify recipients of alerts. (125) The unique dashboard includes but not limited to including: General Dashboard Information: Dashboard specifications, Categories of Objects to be detected, Category List, Subcategory list, Alert types, Alert recipients, Alert Priority, Standard Object, Standard Object Selection Criteria, and Standard Object Selection Rubric, Client's State Criteria; and Alerts Information: the time, frequency, recipients, delivery method and user rights for an alert, Alert Triggers, Alert Trigger States, Alert Trigger parameter criteria, and Alert Trigger State parameter criteria, Alert system start date and time, and end date and time, Client Identification Number; and Worksite Information: Worksite latitude/longitude, worksite boundary perimeter, worksite boundary perimeter GPS coordinates, sub-area boundary, sub-area description, sub-area GPS coordinates, field of view GPS coordinates. Worksite street or physical location address; and Image Description Information: Standard Images of Objects and Objects to be detected including vehicles, people, equipment, dumpsters, materials, and other Objects; and Alert Equipment Information: Equipment object capture requirements, equipment description, equipment specifications.
d) An operator establishes a Dashboard for a Client Alert System process and assigns the Dashboard a unique ID number. The unique Identification Number incorporates a numeric chronological feature, and a multi-level and hierarchical sequence numbering feature. An operator uploads a Client Dashboard identification information and identification number; General Dashboard Information; Worksite Information; and Alert Equipment Information to a Client Project Folio. (127) e) An operator uploads a Client's identification information to a Client Project Folio (10). (129)
f) An operator uploads the Dashboard specification to a Dashboard Docu-Vault including, but not limited to including, dashboard specifications, Categories of Objects to be detected, Category List, Subcategory list, Alert types, Alert recipients, Alert Priority, Standard Object, Standard Object Selection Criteria, and Standard Object Selection Rubric, Client's State Criteria, and Dashboard Identification number. (131)
g) An operator uploads the worksite street location or physical location to a Dashboard Docu-Vault. (133)
h) An operator determines the geographic coordinates for the worksite location boundary including, but not limited to north, south, east, west coordinates, detail perimeter coordinates and What3Words locations. (135)
i) An operator uploads the geographic coordinates for the worksite location boundary to the Worksite Docu-Vault. (137)
j) An operator uploads the Alert System start date and time, and the end date and time to the Dashboard Docu-Vault. (139)
k) An operator uploads the name, title, contact information and user rights for each recipient to the Dashboard Docu-Vault. (141)
l) An operator uploads the following, but is not limited to the following, to a Client Project Folio: worksite street location, worksite geographic location; worksite boundary location, worksite boundary geographic location, user information, user rights. (143)

FIG. 3: Client defines Alerts needed, frequency, delivery.

As illustrated in FIG. 3 this method comprises a plurality of sub-methods or sub-processes, as set forth below, for a Client to define the Alerts need, frequency, delivery and user rights.

FIG. 3) Method for a Client to define, but not limited to defining, the Alerts needed, their frequency, recipients internal to the Client and external to the Client, and delivery methods.
a) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
b) A Client determines, but is not limited to determining, the preferences for Alerts as follows
   1) A Client determines, but is not limited to determining, the time, frequency, recipients, delivery method and user rights for an Alert. (151)
   2) A Client determines, but is not limited to determining, the time, frequency, recipients, delivery method and user rights for Noisy Alerts. (153)
c) An operator uploads, but is not limited to uploading, the Client preferences for an Alert.
   1) An operator associates the Client preferences including, but is not limited to including, the time, frequency, recipients, data transmission method, delivery method and user rights with an Alert. (155)
      (i) An operator assigns a unique identification number to the preferences for the Alert. (156) The unique Identification Number incorporates a numeric chronological feature, and a multi-level and hierarchical sequence numbering feature. The unique identification number associates the preferences with the Alert. (157)
      (ii) An operator uploads the preferences to an Alert Docu-Vault. (159)
d) An operator uploads, but is not limited to uploading, the Client preferences for Noisy Alerts
   1) An operator associates the preferences including, but is not limited to including, the time, frequency, recipients, delivery method and user rights with a Noisy Alert. (161)
      (i) An operator assigns a unique identification number to the preferences for a Noisy Alert. (xxx) The unique Identification Number incorporates a numeric chronological feature, and a multi-level and hierarchical sequence numbering feature. The unique identification number associates the preferences with a Noisy Alert. (163)
      (ii) An operator uploads the Noisy Alert preferences to an Alert Docu-Vault. (165)

FIG. 4: Client defines the Alert Category and a Safety Priority for Objects to be detected and monitored on the Client worksite as a subject of an Alert.

As illustrated in FIG. 4 this method comprises a plurality of sub-methods or sub-processes, as set forth below, to identify and defines the Alert Category and a Safety Priority for Objects to be detected and monitored on the Client worksite as a subject of an Alert.

FIG. 4) Method to identify and determine the category and subcategory names of Objects to be detected and monitored on the Client worksite as a subject for an Alert.
a) An operator determines an Object to be detected and monitored on the Client worksite as a subject of an Alert including, but is not limited to including, a physical object, an image of a physical object, a person, vehicle, equipment, materials, Client defined Objects, sensor measurement, environment condition, weather condition, event, regulatory compliance condition, Client defined conditions, a data element, or an information item, word or phrases and is hereinafter called ‘Object’. An operator assigns the Object Name and identification number and uploads the Object Name to a Dashboard Docu-Vault. (171)
b) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
c) A Client accesses a Dashboard Docu-Vault and selects an Object Name. (173)
d) A Client uses an Object Name from a Dashboard Docu-Vault. A Client selects an image identical or similar to the Object Name from an Image Description Docu-Vault together with the standard names for an Object Category and Sub-category but is not limited to a category or sub-category, of Objects or data elements, or information items used to recognize and detect an Object as the subject of an Alert. (175)
e) Client uploads the name for a category, and sub-category, but is not limited to a single category or sub-category, of Objects to recognize and detect to the Dashboard Docu-Vault. (177)
f) An operator verifies a category and sub-category list, but not limited to a list, created by the Client. The category and sub-category list are used to describe Objects to be detected as a subject for an Alert from the Dashboard Docu-Vault, hereinafter called ‘Alert Category’ and ‘Alert Subcategory’. An operator updates the category and subcategory description in the Dashboard Docu-Vault with a unique identification number. The unique Identification Number incorporates a numeric chronological feature, and a multi-level and hierarchical sequence numbering feature to associate, but is not limited to associating, a category and subcategory with a Client worksite. (179)
g) An operator accesses the ‘Safety Priority’ and compliance information for an Alert Category and Alert Subcategory from a Safety Compliance Docu-Vault. (181)
h) An operator assigns Safety Priority to an Alert Category for an Alert. An operator assigns a unique identification number to a Safety Priority for an Alert Category and Alert Subcategory. The unique Identification Number incorporates a numeric chronological feature, and a multi-level and hierarchical sequence numbering feature. The unique identification number associates a Safety Priority with an Alert Category and Alert Subcategory. An operator uploads a Safety Priority for an Alert Category and an Alert Subcategory to a Dashboard Docu-Vault. (183)
i) An operator time stamps and updates the Client Project Folio with a Safety Priority, an Alert Category and an Alert Subcategory. (185)

FIG. 5: Select Standard Objects and Object Images for a Category of Objects and Objects to be detected for an Alert on the Client worksite.

As illustrated in FIG. 5 this method comprises a plurality of sub-methods or sub-processes, as set forth below, to select Standard Objects for a category and subcategory and Objects and Object Images to be detected for an Alert on the Client worksite.

FIG. 5) Method to Select Standard Objects for a category of Objects and Objects to be detected for an Alert on the Client worksite.
a) An operator uses the following methods and processes for Alerts including, but is not limited to including, the following Alerts, Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
b) An operator creates Standard Object Selection Criteria. (191)
c) An operator establishes a Standard Object Selection Criteria, Standard Object Selection Rubric, rules, and algorithm for selecting Standard Objects which match Alert Category and Alert Subcategory descriptions from but is not limited from including Objects and Object Images from, EarthCam proprietary EC Images Docu-Vaults, from third party augment image data stores and third-party object data stores, hereinafter called Standard Object Selection Process. (xx). The rubric may be metric, digital, subjective or any combination. The rubric, rules, and algorithms provide the operator with a method for grading the outcome of the Standard Object Selection Process and determining if the Standard Object Selection Rubric Score is acceptable. An operator uses a value of 10 but not limited to 10 to indicate a score which is acceptable. An operator uses a value of 1 but not limited to 1 to indicate a score which is not adequate. (193)
d) An operator assigns a Standard Object Selection Criteria, Standard Object Selection Rubric, and rubric score a unique identification number. The unique Identification Number incorporates a numeric chronological feature, and a multi-level and hierarchical sequence numbering feature to associate, but is not limited to associating, an Object Selection Criteria, Standard Object Selection Rubric, and rubric score to a Client, a worksite, an Alert Category, an Alert Subcategory and a Safety Priority. An operator uploads a Standard Object Selection Criteria, and Standard Object Selection Rubric to the Dashboard Docu-Vault with a unique Identification Number.
e) An operator accesses, but is not limited to accessing, an EC Images Docu-Vault and a third-party Object data store for Objects and Object Images which match the Alert Category and Alert Subcategory descriptions. (195)
f) An operator selects Objects and Object Images from an EC Images Docu-Vault which match the descriptions of Objects associated with an Alert Category and Alert Sub-category. (197)
g) An operator reviews the Objects and Object Images from, but not limited to, an EC Images Data-Vault. (199)
h) An operator performs the Standard Object Selection Rubric process for determining if the Standard Object Selection Process is acceptable or not acceptable. (201)
i) An operator updates the Client Request Docu-Vault with a rubric score for the outcome of the Standard Object Selection Process. An operator updates Standard Object Selection Rubric score in Dashboard docu-vault with a score for the outcome of the Standard Object Selection Process being acceptable or not acceptable process. (203)
j) An operator uses Standard Object Selection Rubric. (205)
k) If the Standard Object Selection Rubric score is not acceptable an operator uses an EarthCam Algorithms for a Docu-Narrative Instruction Set and procedure to select another Object. (207)
l) If the Object Selection Rubric score is acceptable and Operator selects the Standard Object and Standard Object Image. (209)
m) An operator assigns a unique identification number to a Standard Object and Standard Object Image. The unique Identification Number incorporates a numeric chronological feature, and a multi-level and hierarchical sequence numbering feature. The unique identification number associates a Standard Object and Standard Object Image with, but is not limited to, an Alert Category, Alert Subcategory, Safety Priority, Client Worksite location. An operator uploads a Standard Object and Standard Object Image to a Standard Image Docu-Vault. (211) FIG. 6: Client defines the User preferences for an Alert to be associated with the Client worksite.

As illustrated in FIG. 6 this method comprises a plurality of sub-methods or sub-processes, as set forth below, for a Client to define the User preferences for an Alert to be associated with the Client worksite.

FIG. 6) Method for a Client to define the preferences for the following but is not limited to the following Alerts to be associated with the Client worksite.
a) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
b) A Client accesses an Alert Docu-Vault (14) and A Client accesses an Alert. (221)
   1) A Client identifies and uploads a user identification, user rights, not limited to viewing, adding, deleting, modifying an Alert. (223)
   2) A Client identifies and uploads, but is not limited to, Recipient's identification, recipient's name, email address, telephone, fax, street address for an Alert. (225)
   3) A Client determines and uploads if the Alert is for a single or multiple occurrences. (227)
   4) A Client determines and uploads, but is not limited to uploading, the frequency of occurrence, time of day, the day or days of the week for the Alert. (229)
   5) A Client determines the start and end day and time for issuing the Alert. (231)
   6) An operator assigns a unique identification number to the user, recipient, occurrences, frequency of occurrence, Alert start and end date and time. The unique Identification Number incorporates a numeric chronological feature, and a multi-level and hierarchical sequence numbering feature. The unique identification number associates the user, recipient, occurrences, frequency of occurrence, Alert start and end date and time with an Alert. (233)
   7) An operator uploads the user, recipient, occurrences, frequency of occurrence, Alert start and end date and time to an Alert Docu-Vault. (235)

FIG. 7: Operator determines the data capture equipment needed to produce an Alert As illustrated in FIG. 7 this method comprises a plurality of sub-methods or sub-processes, as set forth below, to determine the data capture equipment needed to produce an Alert.

FIG. 7) Method to determine the equipment needed to produce an Alert.
a) Data Capture Equipment for an Alert includes, but is not limited to including, cameras, sensors, alarms, lights, locks, motion sensors, measuring instruments, radiation sensors, weather equipment, air particle sensors, windspeed sensors, internet of things devices, and other devices required for an Alert and are hereinafter called ‘Equipment’.
b) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
c) An operator establishes standard data capture equipment requirements, for an Alert.
   1) An operator creates Data Capture Requirements criteria for Equipment required for an Alert. An operator uploads the Equipment Data Capture Requirements Criteria for the Alert to an Alert Equipment Docu-Vault (24). (241)
   2) An operator establishes a Data Capture Equipment Criteria, a Data Capture Equipment Rubric, and a rubric score for determining if a piece of Equipment is adequate for the Alert. (243)
   3) An operator accesses a Data Capture Equipment Docu-Vault (26) and selects a Data Capture Equipment candidate for possible use as Data Capture Equipment for an Alert. (245)
   4) An operator uses a Data Capture Equipment Criteria, and Data Capture Equipment Rubric to determine if the Data Capture Equipment candidate for an Alert is adequate. (247)
   5) If the Data Capture Equipment Rubric score is not adequate, an operator selects another Data Capture Equipment candidate. (253)
   6) If the Data Capture Equipment Rubric score is adequate, an operator selects the Data Capture Equipment and assigns a unique identification number to the equipment. The unique Identification Number incorporates a numeric chronological feature, and a multi-level and hierarchical sequence numbering feature. The unique identification number associates the equipment with an Alert. An operator uploads the Data Capture Equipment description but is not limited to the Data Capture Equipment description and specifications, to an Alert Equipment Docu-Vault (24). An operator uploads the Data Capture Equipment Rubric score to the Alert Equipment Docu-Vault. (252)
   7) An operator updates the Client Project Folio (10) with the Data Capture Equipment description and Data Capture Equipment Rubric score. (251)
   8) An operator establishes a Benchmark Object to be used with the Data Capture Equipment and assigns a unique identification number to the equipment. The unique Identification Number incorporates a numeric chronological feature, and a multi-level and hierarchical sequence numbering feature. The unique identification number associates the Benchmark Object with the equipment with an Alert. An operator uploads the Benchmark Object description but not limited to the Benchmark Object description and specifications, to an Alert Equipment Docu-Vault (24). (253)

FIG. 8: Operator installs data capture equipment and systems for an Alert.

As illustrated in FIG. 8 this method comprises a plurality of sub-methods or sub-processes, as set forth below, to install data capture equipment required to create, transmit and record information, data and images for at least one Alert.

FIG. 8) A method to install data capture equipment required to create, transmit and record information, data and images for at least one Alert.
a) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
b) An operator accesses an Alert Equipment Docu-Vault and identifies the data capture equipment and systems, information, data and images needed for an Alert Trigger, and Alert Trigger State, Alert Trigger State Parameter for an Alert. (261)
c) An operator uses an EarthCam Algorithms and Instruction Set, criteria, rubrics, and rubric scores to select a benchmark for a data capture equipment. An operator uses an EarthCam Algorithms and Instruction Set operator uses at least one EarthCam Algorithms and Instruction Set, criteria, rubrics, and rubric scores to determine and select an outcome or an output for a benchmark for a data capture equipment. (262)
d) An operator uses an EarthCam Algorithms and Instruction Set to define the installation setup instructions for the data capture equipment, systems, information, data and images for an Alert including the geographic location, but not limited to a single location, a scan, tilt, a Benchmark Object, a Benchmark Object geographic location, equipment mounting, power, backup power, communication, monitoring, measurement calibrations, and permits. (263)
e) An operator assigns a unique identification number to a data capture equipment and systems setup instructions for an Alert. The unique Identification Number incorporates a numeric chronological feature, and a multi-level and hierarchical sequence numbering feature. The unique identification number associates the data capture equipment and systems setup instructions with an Alert. An operator uploads the data capture equipment and systems setup instructions to an Alert Equipment Docu-Vault. (265)
f) A remote operator travels to Client worksite to install the data capture equipment and systems for an Alert. (267)
g) A remote operator installs the data capture equipment and systems at the worksite using the installation setup instructions. (269)
h) An operator verifies and tests Alert system data capture equipment with and without an associated Benchmark Object at the worksite. (271)
i) A remote operator gets a ground truth geographic location for the data capture equipment for an Alert. An operator assigns a unique identification number to a ground truth geographic location for data capture equipment and systems for an Alert. The unique Identification Number incorporates a numeric chronological feature, and a multi-level and hierarchical sequence numbering feature. The unique identification number associates a data capture equipment geographic location with an Alert. An operator uploads an Alert data capture equipment geographic location to an Alert Equipment Docu-Vault. (273)
j) A remote operator gets ground truth geographic location, ground truth dimensions, and pixel dimensions for data capture equipment Benchmark Objects for an Alert.

An operator assigns a unique identification number to a Benchmark Object geographic location for an Alert. The unique Identification Number incorporates a numeric chronological feature, and a multi-level and hierarchical sequence numbering feature. The unique identification number associates a Benchmark Object geographic location with an Alert. An operator uploads a Benchmark Object geographic location to an Alert Equipment Docu-Vault. (275)
k) A remote operator performs a self-test for the Alert data capture equipment and systems at the worksite. (277)
l) A remote operator performs a self-test for the Alert data capture equipment and systems using a Benchmark Object at the worksite. (279)
m) An operator operates the data capture equipment and systems. (281)
n) An operator transmits data from the data capture equipment to a Docu-Vault in an EarthCam Control Center. (283)
o) A remote operator uses an EarthCam Algorithms and Instruction Set to verify the data capture equipment is working properly with the EarthCam Remote Control Center. (285)
p) An operator updates the Client Project Folio with, but is not limited to, the data capture equipment and systems installation setup instructions, installation date, self-test results, test results, equipment description, Benchmark Object description, equipment geographic location and Benchmark Object geographic location. (287)
q) An operator updates an Alert Equipment Docu-Vault with, but is not limited to, the data capture equipment and systems installation setup instructions, installation date, self-test results, test results, equipment description, Benchmark Object description, equipment geographic location and Benchmark Object geographic location. (288)

FIG. 9: Operator creates an Alert Trigger, an Alert Trigger State, and Alert Trigger State Parameter and Criteria for an Alert.

As illustrated in FIG. 9 this method comprises a plurality of sub-methods or sub-processes, as set forth below, for an operator to create an Alert Trigger, an Alert Trigger State, and an Alert Trigger State Parameter and Criteria for an Alert, and to allow a Client to edit, add or delete an Alert Trigger, an Alert Trigger State, and an Alert Trigger State Parameter and Criteria for an Alert.

FIG. 9) Method for an operator to create an Alert Trigger, an Alert Trigger State, and an Alert Trigger State Parameter and Criteria for an Alert, and to allow a Client to edit, add or delete an Alert Trigger, an Alert Trigger State, and an Alert Trigger State Parameter and Criteria for an Alert.
a) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
b) An operator accesses an Alert Trigger Docu-Vault. (291)
c) An operator creates and defines an Alert Trigger or Triggers, an Alert Trigger State or States, and an Alert Trigger State Parameter and Criteria or Parameters and Criteria for an Alert.
   1) An operator creates, defines and establishes an Alert Trigger for an Alert. An operator assigns a unique identification number to the Alert Trigger. The unique Identification Number incorporates a numeric chronological feature, and a multi-level and hierarchical sequence numbering feature. The unique identification number associates an Alert Trigger with an Alert. An operator uploads the Alert Trigger to an Alert Docu-Vault. (293)
   2) An operator creates, defines and establishes an Alert Trigger State for an Alert.
   3) An operator uses an EarthCam Algorithms and Instruction Set to define and create a quantitative value for each degree of an Alert Trigger State condition.
   4) An operator uses the Alert Trigger State defined in the Alert Trigger Docu-Vault. An operator assigns a unique identification number to the Alert Trigger State. The unique Identification Number incorporates a numeric chronological feature, and a multi-level and hierarchical sequence numbering feature. The unique identification number associates the Alert Trigger State with the Alert. An operator uploads the Alert Trigger State to an Alert Docu-Vault. (295)
   5) An operator creates, defines and establishes an Alert Trigger State Parameter and Criteria for an Alert. An operator assigns a unique identification number to the Alert Trigger State Parameter. The unique Identification Number incorporates a numeric chronological feature, and a multi-level and hierarchical sequence numbering feature. The unique identification number associates the Alert Trigger State Parameter with the Alert. An operator uploads the Alert Trigger State Parameter to an Alert Docu-Vault. (297)
      (i) An operator establishes an Alert Trigger State Parameter Criteria, an Alert Trigger State Parameter Rubric, and a rubric score for determining if an Alert should be created and sent to a Client. An operator assigns a unique identification number to an Alert Trigger State Parameter Criteria, an Alert Trigger State Parameter Rubric. The unique Identification Number incorporates a numeric chronological feature, and a multi-level and hierarchical sequence numbering feature. The unique identification number associates an Alert Trigger State Parameter Criteria, an Alert Trigger State Parameter Rubric, with an Alert. An operator uploads an Alert Trigger State Parameter Criteria, an Alert Trigger State Parameter Rubric to an Alert Trigger Docu-Vault. (299)
   6) An operator uses the Alert Trigger for an Alert as defined in the Alert Trigger Docu-Vault. (301)
   7) uses the Alert Trigger State for an Alert as defined in the Alert Trigger Docu-Vault. (303)
   8) An operator uses the Alert Trigger State Parameter and Criteria defined in the Alert Trigger Docu-Vault for the Alert. (305)
d) An operator accesses an Alert from an Alert Trigger Docu-Vault.
e) An operator edits, adds or deletes an Alert Trigger for an Alert. An operator uploads the edited Alert Trigger to an Alert Trigger Docu-Vault. (307)
f) An operator edits, adds or deletes an Alert Trigger State for an Alert. An operator uploads the edited Alert Trigger State to an Alert Trigger Docu-Vault. (309)
g) An operator edits, adds or deletes an Alert Trigger State Parameter and Criteria for an Alert. An operator uploads the edited Alert Trigger State Parameter and Criteria to an Alert Trigger Docu-Vault. (311)
h) A Client determines the Noisy Alert parameters for an Alert. A Noisy Alert parameter identifies when the alert may not be sent to a recipient. An EarthCam Instruction Set, Algorithms, and Processes for Object Detection and Recognition assigns a unique identification number to the Noisy Alert parameters. The unique Identification Number incorporates a numeric chronological feature, and a multi-level and hierarchical sequence numbering feature. The unique identification number associates the Noisy Alert parameters with an Alert. (313)
i) An operator reviews a Client's Noisy Alert Parameter edits and uploads the Noisy Alert parameters, for an Alert to an Alert Docu-Vault. (315)

FIG. 10: A method to determine when a current Trigger Value from a data capture equipment device located at a Client worksite, when compared to the Alert Trigger value in an Alert Trigger State at a Client worksite, has become adequate to create an Alert.

As illustrated in FIG. 10 this method comprises a plurality of sub-methods or sub-processes, as set forth below, to determine when a current Trigger Value from a data capture equipment device located at a Client worksite, when compared to the Alert Trigger value in an Alert Trigger State at a Client worksite, has become adequate to create an Alert.

FIG. 10) Method to determine when a current Trigger Value from a data capture equipment device located at a Client worksite, when compared to the Alert Trigger value in an Alert Trigger State at a Client worksite, has become adequate to create an Alert
a) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
b) A process to determine the current status of a Trigger Value for a Data Capture Equipment device at a Client worksite.
   1) An operator, located at an EarthCam Control Center, may connect with a Data Capture Equipment device and request the device to transmit its current Trigger Value. (321)
   2) An operator may establish a schedule which instructs a Data Capture Equipment device (71) to transmit a current Trigger Value to an EarthCam Control Center. The schedule may be stored on or remote from a Data Capture Equipment device. A Data Capture Equipment device may automatically transmit a current Trigger Value to an Operator or Remote Operator according to the schedule. (323)
   3) An operator receives a current Trigger Value from a Data Capture Equipment device (71). An operator assigns a unique identification number to a current Trigger Value. The unique Identification Number incorporates a numeric chronological feature, and a multi-level and hierarchical sequence numbering feature. The unique identification number associates a current Trigger Value with an Alert Trigger, Alert Trigger State and an Alert. An operator uploads a current Trigger Value to a Trigger Value Docu-Vault. (325)
c) A process to determine if a current Trigger Value for a Data Capture Equipment device (71) at a Client worksite is adequate to create an Alert.
   1) An operator establishes a Trigger Value Criteria, Trigger Value Rubric, rules, and algorithm for determining if the current Trigger Value to create an Alert is acceptable or not acceptable. The rubric may be metric, digital, subjective or any combination. The rubric, rules, and algorithm provide the operator with a method for grading if the current Trigger Value, when compared to the Alert Trigger value in an Alert Trigger State, is acceptable or not acceptable creating an Alert and determining if the Trigger Value Rubric score is acceptable creating an Alert. An operator uses a value of 10 but not limited to 10 to indicate a score which is acceptable. An operator uses a value of 1 but not limited to 1 to indicate a score which is not adequate. (327)
   2) An operator selects an Alert, associated with a data capture equipment device, from an Alert Docu-Vault. (329)
   3) An operator assesses an Alert Trigger value, for an Alert Trigger State, associated with an Alert, from an Alert Trigger Docu-Vault. (331)
   4) An operator accesses an Alert Trigger State, for an Alert Trigger State associated with an Alert Trigger, from an Alert Trigger Docu-Vault. (333)
   5) An operator accesses an Alert Trigger State Parameter, for an Alert Trigger State associated with an Alert Trigger, from an Alert Trigger Docu-Vault. (335)
   6) An operator accesses the current Trigger Value for an Alert Trigger State from a Trigger Value Docu-Vault. (337)
   7) An operator uses an EarthCam Instruction Set, Algorithms, and Process to detect, recognize, identify, and format, the current data from a Data Collection Equipment device for use in determining a current Trigger Value. (339)
   8) An operator compares the current Trigger Value to the Alert Trigger value in the Alert Trigger State Parameters. (341)
   9) An operator performs the Trigger Value Rubric process for determining if the current Trigger Value compared to the Alert Trigger value in the Trigger State Parameter is acceptable or not acceptable to create an Alert. (343)
   10) An operator uses a Trigger Value Rubric. (345)
   11) If the Trigger Value Rubric score is not adequate an operator selects another data capture equipment device and an associated Alert. (347)
   12) If the Alert Trigger State Rubric score is adequate, an operator creates an Alert. An operator uploads the Alert to an Alert Docu-Vault with an expected delivery date and time and a unique identification number. The unique Identification Number incorporates a numeric chronological feature, and a multi-level and hierarchical sequence number. (349)
   13) An operator updates the Client Project Folio with a Rubric Score if the current Trigger Value is acceptable to create an Alert. An operator assigns a unique identification number to a Rubic Score. The unique Identification Number incorporates a numeric chronological feature, and a multi-level and hierarchical sequence numbering feature. The unique identification number associates a Rubric Score with a current Trigger Value and an Alert.

An operator uses an Evidentiary Trigger Value Chain of Custody when uploading the current Trigger Value to the Client Project Folio. An operator assigns a unique identification number to a current Trigger Value. The unique Identification Number incorporates a numeric chronological feature, and a multi-level and hierarchical sequence numbering feature. The unique identification number associates a current Trigger Value with an Alert Trigger, Alert Trigger State and an Alert. An operator uploads a Trigger Value to a Trigger Value Docu-Vault and an Alert to an Alert Docu-Vault. (351)
14) An operator assigns a unique identification number to a current Trigger Value.

The unique Identification Number incorporates a numeric chronological feature, and a multi-level and hierarchical sequence numbering feature. The unique identification number associates a current Trigger Value with an Alert Trigger, Alert Trigger State and an Alert. An operator uploads a current Trigger Value and an Alert to a Client Project Folio. (353)

FIG. 11: A process to transmit and deliver an Alert to a Client

As illustrated in FIG. 11 this method comprises a plurality of sub-methods or sub-processes, as set forth below, to transmit and deliver an Alert to a Client.

FIG. 11) Process to transmit and deliver an Alert to a Client.
a) An operator uses the following methods and processes for Alerts including, but is not limited to including, the following Alerts: Camera Online, Camera Tampering, Low Battery Charge, Insufficient Panel Voltage, Power Loss, Bandwidth, Weather Condition, NOOA METAR, Heat Warning, Cold Warning, Heat Index, Precipitation, Humidity, High Winds, Wind Gusts, Lightning, Lightening and People, High Winds and People, Concrete Truck, Compliance, Absence of PPE, Person at Height, People-to-People, People-to-Vehicle, Loitering, Vehicle-to-Vehicle, Equipment, Objects, Dumpster, Fence Guard, Airborne Substances, Regulatory Alerts, Injury, Disaster, and Client Custom Alert.
b) An operator accesses the Alert Docu-Vault by the following methods, but not limited to the following methods: periodically, according to a defined schedule, according to a predefined Alert priority or immediately. (361)
c) An operator uses an EarthCam Algorithms and Instruction Set to identify an Alert which has not been transmitted to a recipient. An operator uses an EarthCam Algorithms and Instruction Set to check for Alerts which may not have a delivery date and time. (363)
d) An operator downloads an Alert which has not been transmitted to a recipient from an Alert Docu-Vault. (365)
e) An operator accesses, but is not limited to accessing, the recipient contact information, data transmission instructions, data transmission method, delivery address for the Alert from an Alert Docu-Vault. (367)
f) An operator transmits the Alert, from an EarthCam Control Center to a Recipient according to the alert data transmission method included in the Alert preferences defined by the Client. An Alert may be transmitted by, but not limited to being transmitted by, email or fax. (369)
g) An operator requests, from the Recipient, a delivery receipt, but not limited to a delivery receipt, acknowledging delivery of the Alert to the Recipient. (371)
h) An operator receives an Alert delivery confirmation from the Recipient. If an operator does not receive an Alert delivery confirmation from the Recipient, an operator retransmits the Alert. (373)
i) An operator updates the Alert with the delivery, and delivery receipt confirmation date and time in the Alert Docu-Vault. (375)
j) An operator updates the Client Project Folio (10) with the Alert, alert delivery, alert delivery receipt confirmation date and time, and the recipient's contact information. (377)
k) An operator updates an (10) with the Alert, alert delivery, alert delivery receipt confirmation date and time, and the recipient's contact information

FIG. 12: Operator creates and maintains a Regulatory Compliance Library

As illustrated in FIG. 12 this method comprises a plurality of sub-methods or sub-processes, as set forth below, to create and maintain a digital regulatory compliance library docu-vault.

FIG. 12) Method to create and maintain a digital regulatory compliance library docu-vault.
a) Regulations include, but are not limited to including, regulations, statutes, case law, standards, policy, procedures, or best practices, and are hereinafter called ‘Citations’.
b) An operator uses a method to acquire, digitize, and maintain a citation library of, but is not limited to, Federal government agency regulations, Federal legislation, and Federal case law related to, and not limited to, worksite activities. (381)
c) An operator assigns a unique identification number to the Federal Citations. The unique Identification Number incorporates a numeric chronological feature, and a multi-level and hierarchical sequence numbering feature. The unique identification number associates a Federal Citations with an Alert Trigger, Alert Trigger State and Alert Trigger State Parameter. An operator uploads Federal Citations to a Regulatory Compliance Docu-Vault. An operator updates a Regulatory Compliance Docu-Vault with the Federal Citations. (383)
d) An operator uses a method to acquire, digitize, and maintain a library of, but is not limited to, State government agency regulations, State legislation, and State case law, related to, and not limited to, worksite activities. (385)
e) An operator assigns a unique identification number to the State Citations. The unique Identification Number incorporates a numeric chronological feature, and a multi-level and hierarchical sequence numbering feature. The unique identification number associates State Citations with an Alert Trigger, Alert Trigger State and Alert Trigger State Parameter. An operator uploads State Citations to a Regulatory Compliance Docu-Vault. An operator updates a Regulatory Compliance Docu-Vault with the State Citations. (387)
f) An operator uses a method to acquire, digitize, and maintain a library of, but is not limited to Local government agency regulations, Local legislation, and Local case law related to, and not limited to, worksite activities. (389)
g) An operator assigns a unique identification number to the Local Citations. The unique Identification Number incorporates a numeric chronological feature, and a multi-level and hierarchical sequence numbering feature. The unique identification number associates Local Citations with an Alert Trigger, Alert Trigger State and Alert Trigger State Parameter. An operator uploads Local Citations to a Regulatory Compliance Docu-Vault. An operator updates a Regulatory Compliance Docu-Vault with the Local Citations. (391)
h) An operator uses a method to acquire, digitize, and maintain a library of, but is not limited to, Industry regulations, industry standards, and industry best practices, related to, but is not limited to, worksite activities. (393)
i) An operator uses a method to assign a unique identification number to the Industry Citations. The unique Identification Number incorporates a numeric chronological feature, and a multi-level and hierarchical sequence numbering feature. The unique identification number associates Industry Citations with an Alert Trigger, Alert Trigger State and Alert Trigger State Parameter. An operator uploads Industry Citations to a Regulatory Compliance Docu-Vault. An operator updates a Regulatory Compliance Docu-Vault with the Industry Citations. (395)
j) An operator uses a method to acquire, digitize, and maintain a library of, but is not limited to, Client regulations, policies, procedures and practices, related to, but is not limited to, worksite activities. (397)
k) An operator assigns a unique identification number to the Client Citations. The unique Identification Number incorporates a numeric chronological feature, and a multi-level and hierarchical sequence numbering feature. The unique identification number associates Client Citations with an Alert Trigger, Alert Trigger State and Alert Trigger State Parameter. An operator uploads Client Citations to a Regulatory Compliance Docu-Vault. An operator updates a Regulatory Compliance Docu-Vault with the Client Citations. (399)
l) An operator uses a method, and an EarthCam Instruction Set, Algorithms, and Process to relate an Alert Trigger, Alert Trigger State and Alert Trigger State Parameter with, but is not limited to, a Citation. (401)
m) An operator uses a method, and an EarthCam Instruction Set, Algorithms, and Process to create, but is not limited to, keywords, relational indexes, normalized tables, concordance indexes, and optimized queries relating Alert Triggers, Alert Trigger States, and Alert Trigger State Parameters with, but is not limited to, Citations. (403)
n) An operator uses a method, and an EarthCam Instruction Set, Algorithms, and Process to identifies and assigns, but not limited to identifying and assigning Alert Triggers, Alert Trigger States, Alert Trigger State Parameters and Citations with keywords, relational indexes, normalized tables, concordance indexes, and optimized query structures.

### TABLE 1

### Table of Docu-Vaults by Name

An alphabetical list of Docu-Vaults used in an Alert System with reference to the drawing item number used to identify the Docu-Vault. The data elements included in a Docu-Vault are listed in the Data Elements column.

| | Drawing | | |
|---|---|---|---|
| FIG. # | Item # | Docu-Vault | Purpose |
| 1, 3 | 14 | Alerts | the time, frequency, recipients, delivery |
| | | Docu-Vault | method and user rights for an alert. An |
| | | | Alert. Alert Triggers, Alert Trigger |
| | | | States, Alert Trigger parameter criteria, |
| | | | and Alert Trigger State parameter |
| | | | criteria, Alert system start date |
| | | | and time, end date and time, |
| | | | Client Identification Number |
| 7, 8 | 24 | Alert | Equipment Object capture requirements, |
| | | Equipment | equipment description, equipment |
| | | Docu-Vault | specifications, Data Capture Equipment |
| | | | Rubric score |
| 2, 4, | 10 | Client | |
| 7, 8 | | Project | |
| | | Folio | |
| 2, 4, | 26 | Dashboard | Dashboard specifications, Object |
| 5, 10 | | Docu-Vault | names, Categories of Objects to |
| | | | be detected, Category List, |
| | | | Subcategory list, Alert types, |
| | | | Alert recipients, Alert Priority, |
| | | | Standard Object, Standard Object |
| | | | Selection Criteria, and Standard |
| | | | Object Selection Rubric, Client's |
| | | | State Criteria, Dashboard |
| | | | Identification number. |
| 5 | 22 | EC Images | Objects |
| | | Docu-Vault | |
| 7 | 16 | Data Capture | Data capture equipment candidate |
| | | Equipment | specifications, descriptions. |
| | | Docu-Vault | |
| 4 | 18 | Image | standard names for an Object category |
| | | Description | and sub-category, |
| | | Docu-Vault | |
| 4 | 20 | Safety | Alert Category Name and description, |
| | | Compliance | Alert Sub-Category Name and |
| | | Docu-Vault | description, Safety priority and |
| | | | compliance description for Alert |
| | | | Category and Alert Subcategory |
| 5 | 34 | Standard | Standard Images of Objects and Objects |
| | | Image | to be detected including vehicles, |
| | | Docu-Vault | people, equipment, dumpsters, |
| | | | materials, and other Objects. |
| 10 | 30 | Trigger | Trigger Value from Date Capture |
| | | Value | Equipment; Camera images, sensor |
| | | | data, weather data |
| 1, 2, | 12 | Worksite | Worksite latitude/longitude, worksite |
| | | Docu-Vault | boundary perimeter, worksite boundary |
| | | | perimeter GPS coordinates, sub-area |
| | | | boundary, sub-area description, sub-area |
| | | | GPS coordinates, field of view GPS |
| | | | coordinates. Worksite street or physical |
| | | | location address. |
| 10 | 32 | Regulatory | |
| | | Compliance | |
| | | Docu-Vault | |

### TABLE 2

### Table for Alert Trigger Docu-Vault (28)

A table of a plurality of specifications for an Alert Name, Alert Trigger Name, Alert Trigger State and an Alert Trigger State Parameter Description.

| | | | Alert | |
|---|---|---|---|---|
| | | Alert | Trigger | |
| | | Trigger | State | |
| # | Alert Name | Name | Name | Alert Trigger State Parameter Description |
| 1 | Camera | Camera | Camera | A camera online or offline, or an image |
| | Online & | Online | Online | present or an image absent, and the |
| | Offline | Sensor | | applicable requirements in the regulation |
| | Monitor | | | parameter, and the requirements in, a |
| | know as | | | Client selected, Client Custom, and other |
| | Camera | | | Alert Trigger State Parameter, as described |
| | Online | | | in the Camera Online parameter |
| 2 | Camera | Camera | Camera | A camera image orientation which is |
| | Tampering | Tampering | Tampering | correct, a camera image orientation which |
| | | Sensor | | is incorrect, and the applicable |
| | | | | requirements in the regulation parameter, |
| | | | | and the requirements in, a Client |
| | | | | selected, Client Custom, and other Alert |
| | | | | Trigger State Parameter, as described in |
| | | | | the Camera Tampering parameter |
| 3 | Noisy | Client | Noisy | Less than meaningful alert as described in |
| | Alerts | Parameter | Alert | the noisy alert parameter, and the |
| | (useless | | | applicable requirements in the regulation |
| | alerts) | | | parameter, and the requirements in, a |
| | Defined in | | | Client selected, Client Custom, and other |
| | definition | | | Alert Trigger State Parameter, and |
| | part of | | | described in a Noisy Alert parameter. |
| | overview. | | | |
| 4 | Low | Low | Low | A less than minimum battery charge |
| | Battery | Battery | Battery | defined by an operator, and requirements |
| | Charge | Sensor | | and the applicable requirements in the |
| | | | | regulation parameter, and the |
| | | | | requirements in, a Client selected, Client |
| | | | | Custom, and other Alert Trigger State |
| | | | | Parameter, as described in the Low |
| | | | | Battery parameter |
| 5 | Insufficient | Voltage | Voltage | A less than minimum voltage defined by |
| | Panel | Sensor | | an operator, and the applicable |
| | Voltage | | | requirements in the regulation parameter, |
| | | | | and the requirements in, a Client |
| | | | | selected, Client Custom, and other Alert |
| | | | | Trigger State Parameter, as described in |
| | | | | the Voltage parameter |
| 6 | Power Loss | Power | Power | The power on, power off defined by an |
| | for Camera | Loss | Loss | operator, and the applicable requirements |
| | and other | Sensor | | in the regulation parameter, and the |
| | Devices | | | requirements in, a Client selected, Client |
| | Alerts | | | Custom, and other Alert Trigger State |
| | Known as | | | Parameter, as described in the Power Loss |
| | ‘Power | | | parameter |
| | Loss’ | | | |
| 7 | Bandwidth | Bandwidth | Bandwidth | A data communication data transmission |
| | | Sensor | | connection on, or a connection off, or a |
| | | | | connection in bits per second less than |
| | | | | minimum number of bits per second as |
| | | | | defined by an operator, and the applicable |
| | | | | requirements in the regulation parameter, |
| | | | | and the requirements in, a Client |
| | | | | selected, Client Custom, and other Alert |
| | | | | Trigger State Parameter, as described in |
| | | | | the Bandwidth parameter |
| 8 | Weather | Weather | Weather | An environmental condition including, but |
| | Condition | Sensor | | is not limited to, temperature, humidity, |
| | | | | precipitation, sunlight, storms, tornadoes, |
| | | | | earthquakes, ground tremors, flooding, |
| | | | | wind speed, wind direction, freezing more |
| | | | | than defined by an operator or less than |
| | | | | defined by an operator, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Weather parameter. |
| 9 | NOOA METAR | METAR | METAR | A METAR data set including, but is not |
| | Condition | Report | | limited to Temperature, Wind Speed, Wind |
| | Alerts | (current | | Gust, Precipitation in Inches, Humidity, |
| | (Meteorological | report | | and Heat Index, which is less than a low |
| | Terminal Air | from | | METAR parameter, or greater than a high |
| | Report) known | Nearest | | METAR parameter, or more current than a |
| | as ‘NOOA | airport) | | previous METAR parameter, and the |
| | METAR’ | | | applicable requirements in the regulation |
| | | | | parameter, and the requirements in, a |
| | | | | Client selected, Client Custom, and other |
| | | | | Alert Trigger State Parameter, and |
| | | | | described in a METAR parameter. |
| 10 | Heat Warning - | Heat | Heat | A temperature equal to or greater than a |
| | Over 90 F., | Sensor | | high heat parameter, or 90° F., but is not |
| | known as | | | limited to 90° F., and the applicable |
| | ‘Heat | | | requirements in the regulation parameter, |
| | Warning’ | | | and the requirements in, a Client |
| | | | | selected, Client Custom, and other Alert |
| | | | | Trigger State Parameter, and described in |
| | | | | a Heat parameter. |
| 11 | Cold Warning - | Cold | Cold | A temperature equal to or lower than a |
| | Under 32 F. | Sensor | | Cold parameter, or 32° F., but is not limit to |
| | known | | | 32° F., and the applicable requirements in |
| | as ‘Cold | | | the regulation parameter, and the |
| | Warning’ | | | requirements in, a Client selected, Client |
| | | | | Custom, and other Alert Trigger State |
| | | | | Parameter, and described in a Cold |
| | | | | parameter. |
| 12 | Heat Index - | Heat Index | High Heat | A temperature equal to or greater than a |
| | Over 91 F. | Sensor | Index | High Heat Index parameter, or 91° F., but is |
| | known as | | | not limited to 91° F., and the applicable |
| | ‘Heat | | | requirements in the regulation parameter, |
| | Index’ | | | and the requirements in, a Client |
| | | | | selected, Client Custom, and other Alert |
| | | | | Trigger State Parameter and described in a |
| | | | | High Heat Index parameter. |
| 13 | High Winds - | Wind | Wind | A wind speed and wind direction equal to |
| | Over 25 MPH | Speed | Speed | or greater than a high wind speed |
| | known as | Sensor | | parameter or a wind speed less than or |
| | ‘High | | | wind direction not equal to a high wind |
| | Winds’ | | | speed parameter, and a tornado, and a |
| | | | | hurricane, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Wind Speed parameter. |
| 14 | Wind Gusts - | Gust | Gust | A wind gust speed and wind gust direction |
| | Over 35 MPH | Sensor | | equal to or greater than a high wind gust |
| | known as | | | speed parameter or a wind gust speed |
| | ‘Wind | | | less than or wind gust direction not equal |
| | Gusts’ | | | to a high wind gust speed parameter, and |
| | | | | the applicable requirements in the |
| | | | | regulation parameter, and the |
| | | | | requirements in, a Client selected, Client |
| | | | | Custom, and other Alert Trigger State |
| | | | | Parameter, and described in a Gust |
| | | | | parameter. |
| 15 | Lightning | Lightening | Lightening | a decibel rate lower than or greater than or |
| | | Sensor | | not equal to a lightening parameter, or a |
| | | | | lightening image visible in camera image |
| | | | | of worksite, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Lightening parameter. |
| 16 | Precipitation - | Rain-Snow | Rain-Snow | the inches or millimeters of accumulated |
| | Rain or snow | Sensor | | rain above or below or not equal to a |
| | over 0.75 | | | maximum rain height parameter; or inches |
| | Know as | | | or millimeters of accumulated snow |
| | ‘Precipitation’ | | | above, below or not equal to a maximum |
| | Rain measure | | | snow height parameter; or inches or |
| | to predict | | | millimeters of accumulated ice above, |
| | flooding | | | below or not equal to a maximum ice |
| | | | | height parameter, or Meteorological |
| | | | | Optical Range (MOR) above, below or not |
| | | | | equal to a maximum visibility distance fog |
| | | | | parameter, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Rain-Snow parameter. |
| 17 | Humidity - | Humidity | Humidity | The percent of relative humidity (RH) |
| | over 90% | Sensor | | higher than a high relative humidity |
| | Known as | | | parameter, lower than a low relative |
| | ‘Humidity’ | | | humidity parameter or equal to a relative |
| | | | | humidity parameter, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Humidity parameter. |
| 18 | Lightning | Lightning | Lightning- | Lightening visible in camera image of |
| | and a Person | Sensor | Person | worksite AND a person above a safe height |
| | at Height | 1. Lightning | | with a lightening present parameter AND |
| | known as | Sensor | | an object of a person exposed to lightning, |
| | ‘Lightening | 2. Person | | and the applicable requirements in the |
| | and People’ | | | regulation parameter, and the |
| | | | | requirements in, a Client selected, Client |
| | | | | Custom, and other Alert Trigger State |
| | | | | Parameter, and described in a Lightning- |
| | | | | Person parameter. |
| 19 | High Winds | Wind Speed | High Winds- | Wind speed and direction equal to or |
| | and Person | Sensor and | Person | greater than high wind speed parameter |
| | at Height | Person | | AND person above the safe height |
| | known as | 1: Wind | | parameter with high winds present AND |
| | ‘High Winds | Speed | | an object of a person exposed to high |
| | and People’ | Sensor | | winds, and the applicable requirements in |
| | | 2: Person | | the regulation parameter, and the |
| | | | | requirements in, a Client selected, Client |
| | | | | Custom, and other Alert Trigger State |
| | | | | Parameter, and described in a High Winds- |
| | | | | Person parameter. |
| 20 | Precipitation, | Concrete | Concrete | Inches or millimeters of accumulated rain |
| | Freeze and | Truck | truck | above a maximum rain height parameter. |
| | Concrete | 1: Concrete | | OR Inches or millimeters of accumulated |
| | Truck | Truck | | snow above a maximum snow height |
| | known as | 2: Rain- | | parameter. |
| | ‘Concrete | Snow | | OR Temperature equal to or greater than a |
| | Truck’ | Sensor | | low parameter AND a concrete truck |
| | | | | object OR a waif artifact of a concrete |
| | | | | truck object, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Concrete Truck parameter. |
| 21 | Safety, | Regulation | Regulation | a regulation, case law, rule, instruction, |
| | Security, | | | best practice, or requirement and not |
| | Regulatory | | | limited to the foregoing, belonging to, but |
| | Compliance, | | | is not limited to, a federal, national, state, |
| | known as | | | province, county, city, local, or |
| | ‘Compliance’ | | | international government, but is not |
| | | | | limited to, government, agency, trade |
| | | | | association, business entity, trade union |
| | | | | or Client as described in the compliance |
| | | | | parameter as being broken, lapsed, |
| | | | | transgressed, illegal, or another action |
| | | | | and hereinafter called 'regulation |
| | | | | parameter', and the requirements in, a |
| | | | | Client selected, Client Custom, and other |
| | | | | Alert Trigger State Parameter, and |
| | | | | described in a Regulation parameter. |
| 22 | Absence of PPE | PPE | PPE | An object of a person that is required to |
| | | 1: PPE | | wear personal protective equipment |
| | | 2: Person | | described by the PPE (personal protection |
| | | | | equipment) parameter AND an object of |
| | | | | personal protective equipment as |
| | | | | described by the PPE parameter AND the |
| | | | | absence of required PPE being worn by the |
| | | | | person as described in the PPE parameter, |
| | | | | and the applicable requirements in the |
| | | | | regulation parameter, and the |
| | | | | requirements in, a Client selected, Client |
| | | | | Custom, and other Alert Trigger State |
| | | | | Parameter, and described in a PPE |
| | | | | parameter. |
| 23 | Person at | Person at | Person at | An object of a person above the safe |
| | Height | Height | Height | height parameter, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Person at Height parameter. |
| 24 | Person to | Person and | Person- | An object of a person in proximity to an |
| | Person | Another | Person | object of another person AND the |
| | proximity | Person | | distance between the two persons are |
| | know as | Person 1 | | less than the minimum distance |
| | ‘People-to- | Person 2 | | described in the person-to-person |
| | People’ | | | parameter, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Person-Person parameter. |
| 25 | Person to | Person and a | Person- | An object of a person in proximity to an |
| | Vehicle | Vehicle | Vehicle | object of a vehicle AND the distance |
| | proximity | 1: Person | | between the person and the vehicle less |
| | known as | 2: Vehicle | | than the minimum distance described in |
| | ‘People-to- | | | the person-to-vehicle parameter, and the |
| | Vehicle’ | | | applicable requirements in the regulation |
| | | | | parameter, and the requirements in, a |
| | | | | Client selected, Client Custom, and other |
| | | | | Alert Trigger State Parameter, and |
| | | | | described in a Person-Vehicle parameter. |
| 26 | Loitering | Person | Loitering | An object of a person who has not moved |
| | | | | for more than the minimum number of |
| | | | | minutes in the loitering parameter OR an |
| | | | | object of a person prohibited from the |
| | | | | worksite as described in the loitering |
| | | | | parameter, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a PPE parameter. |
| 27 | Vehicle to | Vehicle and | Vehicle- | An object of a vehicle in proximity to an |
| | Vehicle | Another | Vehicle | object of another vehicle and the distance |
| | Proximity | Vehicle | | between the two vehicles is less than the |
| | knowns as | Vehicle 1 | | minimum distance, and the applicable |
| | ‘Vehicle-to- | Vehicle 2 | | requirements in the regulation parameter, |
| | Vehicle’ | | | and the requirements in, a Client |
| | | | | selected, Client Custom, and other Alert |
| | | | | Trigger State Parameter, and described in |
| | | | | the Vehicle-Vehicle parameter. |
| 28 | Selected | Equipment | Equipment | an equipment item as described in the |
| | equipment is | | | equipment parameter being absent or |
| | detected | | | being present or another state, and the |
| | known as | | | applicable requirements in the regulation |
| | ‘Equipment’ | | | parameter, and the requirements in, a |
| | | | | Client selected, Client Custom, and other |
| | | | | Alert Trigger State Parameter, and |
| | | | | described in an Equipment parameter. |
| 29 | Any Object | Detection | Detection | an Object, identified by a Client, as |
| | Detection | Object | Object | described in the Object parameter being |
| | known as | | | absent, present, empty, full, not empty or |
| | ‘Objects’ | | | another state, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Detection Object parameter. |
| 30 | Dumpster | Dumpster | Dumpster | An object of a dumpster as described in |
| | empty, full, | | | the dumpster parameter being absent or |
| | removal | | | being present, empty, full, or not empty or |
| | known as | | | another state, and the applicable |
| | ‘Dumpster’ | | | requirements in the regulation parameter, |
| | | | | and the requirements in, a Client |
| | | | | selected, Client Custom, and other Alert |
| | | | | Trigger State Parameter, described in a |
| | | | | Dumpster parameter. |
| 31 | Fence Guard | Fence | Fence | a fence, or sections of a fence as |
| | | Sensor | | described in the fence parameter being |
| | | | | absent or being present, breached, down, |
| | | | | or another state, OR a fence sensor being |
| | | | | on, off, active, inactive, or another state, |
| | | | | and the applicable requirements in the |
| | | | | regulation parameter, and the |
| | | | | requirements in, a Client selected, Client |
| | | | | Custom, and other Alert Trigger State |
| | | | | Parameter, and described in a Fence |
| | | | | parameter. |
| 32 | Airborne | Airborne | Substance | an airborne substance as described in the |
| | Substances | Substance | | substance parameter, but is not limited to, |
| | | Sensor | | being absent or being present or being |
| | | | | toxic or being radioactive or exceeding a |
| | | | | maximum value or being less than a |
| | | | | minimum value, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | a Substance parameter. |
| 33 | Client | Client | Client | an item, defined by the Client, as |
| | Custom | Defined | Custom | described in the client custom parameter |
| | | An item | | being absent, being present, on time, late, |
| | | defined | | or another state, and the applicable |
| | | by the | | requirements in the regulation parameter, |
| | | Client | | and the requirements in, a Client |
| | | | | selected, Client Custom, and other Alert |
| | | | | Trigger State Parameter, and described in |
| | | | | a Client Custom parameter. |
| 34 | Injury | Injured | Injury | an object of a person who experiences an |
| | | People and | | injury defined in the injury parameter OR a |
| | | Vehicles | | person requiring medical attention at the |
| | | | | worksite as described injury parameter, or |
| | | | | a an object of a vehicle or heavy |
| | | | | equipment in an accident or requiring |
| | | | | assistance as defined in the injury |
| | | | | parameter, and the applicable |
| | | | | requirements in the regulation parameter, |
| | | | | and the requirements in, a Client |
| | | | | selected, Client Custom, and other Alert |
| | | | | Trigger State Parameter, and described in |
| | | | | an Injury parameter. |
| 35 | Disaster | Natural and | Disaster | a worksite that experiences, but is not |
| | | Construction | | limited to including, a natural disaster, |
| | | Disaster | | terrorist assault, construction disaster as |
| | | | | defined in the disaster parameter and the |
| | | | | applicable requirements in the regulation |
| | | | | parameter, and the requirements in, a |
| | | | | Client selected, Client Custom, and other |
| | | | | Alert Trigger State Parameter, and |
| | | | | described in a Disaster parameter. |

### TABLE 3

### Alphabetical List of Alert System Rubrics

An alphabetical list of rubrics with reference to the description and drawing figure in which they occur in an Alert System.

| Rubrics | FIG. # |
|---|---|
| Standard Object Selection Rubric | 5 |
| Data Capture Equipment Rubric | 7 |
| Alert Trigger State Parameter Rubric | 9 |
| Trigger Value Rubric | 10 |

### TABLE 4

### Client Project Folio (10)

### Customized, Interlaced and Assembled Worksite Alert System

The Client Request ensures an evidentiary testimonial of the events that occurred at the client location, during the Alert System start and end dates, from images and Trigger Values taken from the client worksite. The chain of custody ensures images and Trigger Values included in the Alert System are relevant, accurate, and have sufficient weight (a measure of the credibility of the image and the image components) to be admitted into the Alert System. It documents, but is not limited to, the acquisition, custody, control, transfer, analysis, and disposition, of the images and Trigger Values in an Alert System.

Docu-Narrative Start Date
Docu-Narrative End Date
Client Name
Client ID Number
Client Location
Client Location ID
Data Capture Equipment ID
Data Capture Equipment Location

| | | | | |
|---|---|---|---|---|
| | Process | | Operator 1 | Operator 2 |
| | Number | | ID & date | ID & date |
| Control # | (##) | Description | and time | and time |

Process Name

| | | |
|---|---|---|
| FIG. 2 | 128 | Client Dashboard identification |
| | | information and identification |
| | | number; General Dashboard |
| | | Information; Worksite |
| | | Information; and Alert |
| | | Equipment Information to a |
| | | Client Project Folio. |
| FIG. 3 | 129 | Client's identification |
| | | information. |
| | 143 | Worksite street location, |
| | | worksite geographic location; |
| | | worksite boundary location, |
| | | worksite boundary geographic |
| | | location, user information, |
| | | user rights. |
| FIG. 4 | 185 | Safety Priority, an Alert |
| | | Category and an Alert |
| | | Subcategory. |
| FIG. 7. | 251 | Data Capture Equipment |
| | | description and Data |
| | | Capture Equipment Rubric |
| | | score. |
| FIG. 8 | 287 | Data capture equipment |
| | | and systems installation |
| | | date, equipment description, |
| | | Benchmark Object description, |
| | | equipment geographic location |
| | | and Benchmark Object |
| | | geographic location. |
| FIG. 10 | 353 | Current Trigger Value and |
| | | an Alert. |
| FIG. 11 | 377 | Alert, alert delivery, alert |
| | | delivery receipt confirmation |
| | | date and time, and the |
| | | recipient's contact |
| | | information. |

What is claimed is:

1. A method for issuing a notification responsive to a worksite issue at a worksite or at a construction site, the method comprising
identifying alert triggers, wherein an alert trigger comprises a condition at the worksite or the construction site;
collecting data from multiple sensory devices disposed at multiple locations of the worksite or the construction site or proximate the worksite or the construction site, wherein the data relates to one or more alert triggers;
creating a plurality of rubrics for use in determining whether an alert trigger state comprises a worksite issue;
determining a current alert trigger state based on the data; and
analyzing the current alert trigger state by applying the plurality of rubrics thereto and issuing a notification if the current alert trigger state comprises a worksite issue.

2. The method of claim 1, wherein if the current alert trigger state relates to a target object, and wherein if the data discloses only a portion of the target object, the method further comprising generating revised data representing a complete target object, wherein a step of determining comprises determining a current alert trigger state based on the revised data.

3. The method of claim 1, wherein the multiple sensory devices comprise a camera, further comprising a camera at a fixed location, a body-worn camera, or a camera-equipped drone, an orthoimage camera, an IoT sensor, a weather station, a 360° virtual reality camera, a panoramic camera, a license plate camera, a perimeter security camera, an access control camera, sensors, alarms, lights, locks, sensors, measuring instruments, radiation sensors, air particle sensors, windspeed sensors, and internet of things devices.

4. The method of claim 1, wherein the data related to an alert trigger comprises an image, a video, a data element, an information item, a measured value, a numerical value, a word, or a phrase, a sensor measurement, a weather condition, or a condition related to compliance to a regulatory directive.

5. The method of claim 1, wherein the data and results of a step of analyzing are retained according to chain of custody requirements and are never altered.

6. The method of claim 1, wherein a step of issuing a notification is executed when the data satisfies one or more of the plurality of rubrics.

7. The method of claim 1, wherein the data comprises current weather conditions, time of day, and day of week.

8. The method of claim 1, further comprising displaying to a user one or more of the alert triggers, the data, the plurality of rubrics, the alert trigger states, and issued notifications.

9. The method of claim 1, wherein the notification comprises information as to a severity of the worksite issue that generated the notification.

10. The method of claim 9, wherein the severity comprises critical, serious, and routine, and wherein a notification is issued at a predetermined frequency and issued to predetermined recipients.

11. The method of claim 1, wherein the alert triggers are identified by a user and are related to one or more of temperature, humidity, precipitation, pressure, wind speed, wind gusts, heat index, proximity between two objects, proximity between two people, light levels, air quality, glass breaking, smoke detectors, flood detectors, air quality, CO2 sensor, volatile organic compounds sensor, electric power supply, weather conditions, lightning conditions, vehicular status and vehicular proximity, personal protection equipment, people and vehicle proximity, vehicle and vehicle proximity, sensory device status.

12. The method of claim 1, wherein a step of analyzing comprises analyzing two or more concurrent alert trigger states by applying the plurality of rubrics thereto and issuing a notification if the two or more concurrent alert trigger states comprise a worksite issue.

13. The method of claim 1, further comprising analyzing the current alert trigger state by applying the plurality of rubrics thereto and issuing a notification if the current alert trigger state may develop into a worksite issue in a near term.

14. The method of claim 1, wherein a step of issuing a notification further comprises issuing a notification to predetermined recipients, wherein the predetermined recipients are determined based on details of the worksite issue.

15. The method of claim 1, further comprising, retaining, without changing according to chain of custody requirements, data related to target objects, current alert trigger states, application of rubrics thereto, and determinations that alert trigger states did or did not comprise a worksite issue.

16. The method of claim 1, further comprising, determining a boundary of the worksite or the construction site.

17. The method of claim 1, wherein an alert trigger relates to a distance between two objects at a worksite or a construction site.

18. The method of claim 17, wherein one or both of the two objects is identified using a bounding box that defines the location and size of the object.

19. The method of claim 1, further comprising an alert trigger related to regulations that govern conduct at the worksite or construction site.

20. The method of claim 1, wherein an alert trigger comprises a predetermined number of related conditions at the worksite or at the construction site in a predetermined time interval or a frequency with which predetermined conditions occur at the worksite or at the construction site.
